(19) United States
(12) Patent Application Publication
(10) Pub. No.: US 2013/0216250 A1
(43) Pub. Date: Aug. 22, 2013

(54) DEVELOPMENT DEVICE AND IMAGE FORMING APPARATUS INCORPORATING SAME

(71) Applicants: Hideyasu SEKI, Chiba (JP); Yasuyuki Ishii, Tokyo (JP); Yoshiko Ogawa, Tokyo (JP); Osamu Endou, Kanagawa (JP); Yuuji Ishikura, kanagawa (JP); Masayuki Yamane, Kanagawa (JP); Keiichi Yoshida, Kanagawa (JP); Atsushi Kurokawa, Kanagawa (JP); Masahiro Watanabe, Kanagawa (JP); Akihiro Kawakami, Tokyo (JP)

(72) Inventors: Hideyasu SEKI, Chiba (JP); Yasuyuki Ishii, Tokyo (JP); Yoshiko Ogawa, Tokyo (JP); Osamu Endou, Kanagawa (JP); Yuuji Ishikura, kanagawa (JP); Masayuki Yamane, Kanagawa (JP); Keiichi Yoshida, Kanagawa (JP); Atsushi Kurokawa, Kanagawa (JP); Masahiro Watanabe, Kanagawa (JP); Akihiro Kawakami, Tokyo (JP)

(21) Appl. No.: 13/749,028

(22) Filed: Jan. 24, 2013

(30) Foreign Application Priority Data
Feb. 16, 2012 (JP) 2012-031430
Nov. 12, 2012 (JP) 2012-248240

(51) Int. Cl. G03G 15/08

(52) U.S. Cl. CPC G03G 15/0812; G03G 15/0808
USPC 399/53; 399/55; 399/284; 399/103; 399/286

(57) ABSTRACT

A development device includes a developer bearer to carry by rotation developer to a development range facing a latent image bearer, and a developer regulator to adjust an amount of developer transported to the development range by the developer bearer. Multiple projections are formed in a surface of the developer bearer, and the developer bearer rotates in a reverse direction to a direction of rotation for image development while image development is not performed. The developer regulator includes a blade having a first end held by a regulator holder and a second end that contacts the multiple projections formed in the surface of the developer bearer and is disposed in a direction counter to the direction of rotation of the developer bearer for image development.

### CROSS-REFERENCE TO RELATED APPLICATIONS

This patent application is based on and claims priority pursuant to 35 U.S.C. §119 to Japanese Patent Application Nos. 2012-031430 filed on Feb. 16, 2012 and 2012-248240 filed on Nov. 12, 2012, in the Japan Patent Office, the entire disclosure of each of which is hereby incorporated by reference herein.

### BACKGROUND OF THE INVENTION

1. Field of the Invention

The present invention generally relates to a development device and an image forming apparatus, such as a copier, a printer, a facsimile machine, or a multifunction machine having at least two of these capabilities, that includes a development device.

2. Description of the Related Art (or Background Art)

Development devices that include a development roller having surface unevenness are known. For example, JP-2009-198782-A proposes forming regularly projections having a substantially identical height and recesses having a substantially identical depth in the surface of the development roller. Such configurations are advantageous in that toner present on the projections can be removed by a developer regulator (i.e., a doctor blade) and that toner can be retained only in the recesses having an identical or similar depth, arranged regularly, thus keeping the amount of toner carried on the development roller constant over the entire circumference of the development roller. The amount of toner carried to a development range can be set to a desired amount by adjusting capacity of the recesses for containing toner.

However, in the above-described configuration, it is possible that toner coagulates on an upstream wall of the recess of the development roller in the direction of rotation of the development roller.

This phenomenon is described below with reference to FIG. 33 that is an enlarged view of a contact portion between a developer regulator 45X and a development roller 42X. It is to be noted that, in FIG. 33, the development roller 42X rotates in the direction indicated by arrow B (hereinafter “direction B”).

As shown in FIG. 33, multiple projections 42aX and multiple recesses 42bX are formed in the surface of the development roller 42X, and also a surface of the developer regulator 45X is not perfectly smooth but has projections 45PX and recesses of the order of several micron meters. When the projection 45PX on the surface of the developer regulator 45X reaches the recess 42bX of the development roller 42X, an inclined surface of the projection of the development roller on an upstream side in the direction B, in which the development roller 42X rotates, presses toner T present inside the recess 42bX in the direction indicated by arrow Fc (hereinafter “direction Fc”). Accordingly, the toner T inside the recess 42bX is pressed against an upstream wall (enclosed with dotted circle) of the recess 42bX in the direction B, in which the development roller 42X rotates. As a result, toner can coagulate in an area, enclosed by broken lines in FIG. 33, adjacent to the upstream wall of the recess 42bX in the direction B.

### SUMMARY OF THE INVENTION

In view of the foregoing, one embodiment of the present invention provides a development device that includes a developer bearer to carry by rotation developer to a development range facing a latent image bearer, a developer regulator to adjust an amount of developer transported to the development range by the developer bearer, and a driving unit to rotate the developer bearer. Multiple projections are formed in a surface of the developer bearer. The driving unit rotates the developer bearer in a reverse direction to a direction of rotation for image development in a period during which image development is not performed. The developer regulator includes a blade having a first end held by a regulator holder and a second end that contacts the multiple projections formed in the surface of the developer bearer. The second end of the blade is disposed in a direction counter to the direction of rotation of the developer bearer for image development.

Another embodiment provides an image forming apparatus that includes a latent image bearer, a charging member to charge a surface of the latent image bearer, a latent image forming device to form a latent image on the latent image bearer, and the above-described development device.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating an image forming apparatus according to an embodiment;

FIG. 2 is a schematic end-on axial view of a development device according to an embodiment; FIG. 3 is a perspective view of the development device shown in FIG. 2;

FIG. 4 is another perspective view of the development device shown in FIG. 2;

FIG. 5 is an end-on axial view of a development device according to an embodiment;

FIG. 6 is a perspective view that partly illustrates the development device shown in FIG. 5;

FIG. 7 is a perspective view of a development roller according to an embodiment;

FIG. 8 is a side view of the development roller shown in FIG. 7;

FIG. 9 is an enlarged perspective view illustrating an axial end portion of the development device, in which a lower case is omitted;

FIG. 10 is an enlarged perspective view illustrating another axial end portion of the development device, in which the lower case is omitted;

FIG. 11A schematically illustrates an exterior of the development roller;

FIG. 11B is an end-on axial view that illustrates, from a side, a detected member of a measurement device to measure the rotational distance of the development roller;

FIG. 11C is an enlarged view illustrating a surface of the development roller;

FIG. 12 is a cross-sectional view along line A-A shown in FIG. 11C;

FIG. 13 is an enlarged cross-sectional view illustrating a surface of a development roller in which angles formed by projections and recesses are smaller than 90°;

FIG. 14 is an enlarged cross-sectional view illustrating a surface of a development roller in which a part of angles formed by projections and recesses are smaller than 90°;

FIG. 15 is a perspective view of a supply roller;

FIG. 16 is a side view of the supply roller;

FIG. 17 is a perspective view of a doctor blade according to an embodiment;

FIG. 18 is a side view of the doctor blade shown in FIG. 17;

FIG. 19 is an enlarged perspective view illustrating a state in which the development roller is removed from the state shown in FIG. 9;

FIG. 20 is an enlarged perspective view illustrating a state in which the development roller is removed from the state shown in FIG. 10;

FIG. 21 is a perspective view of a paddle;

FIG. 22 is a side view of the paddle shown in FIG. 21;

FIG. 23 is a control block diagram for controlling a development device according to an embodiment;

FIG. 24 is an enlarged view of a contact portion between the development roller and the doctor blade;

FIG. 25 is a flowchart for controlling rotation of the development roller;

FIG. 26 is an enlarged view of the contact portion between the development roller and the doctor blade when the development roller is rotated in reverse;

FIG. 27 is an enlarged view illustrating the contact portion between the development roller and the doctor blade in which toner adheres to the doctor blade;

FIG. 28 is an enlarged view illustrating a state in which toner adheres to the doctor blade after the development device has operated for a long time;

FIG. 29 is an enlarged view illustrating toner adhering to the doctor blade after the development device has operated for a long time;

FIG. 30 illustrates removal of toner from the doctor blade when the development roller is rotated in reverse;

FIG. 31 illustrates an amount or distance by which the surface of the development roller moves in reverse rotation;

FIG. 32 is a graph illustrating the relation between wear of an upstream corner and the force for scraping off toner from the doctor blade; and

FIG. 33 is an enlarged view of a contact portion between a development roller and a doctor blade according to a related art, during normal rotation of the development roller.

### DETAILED DESCRIPTION OF THE INVENTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

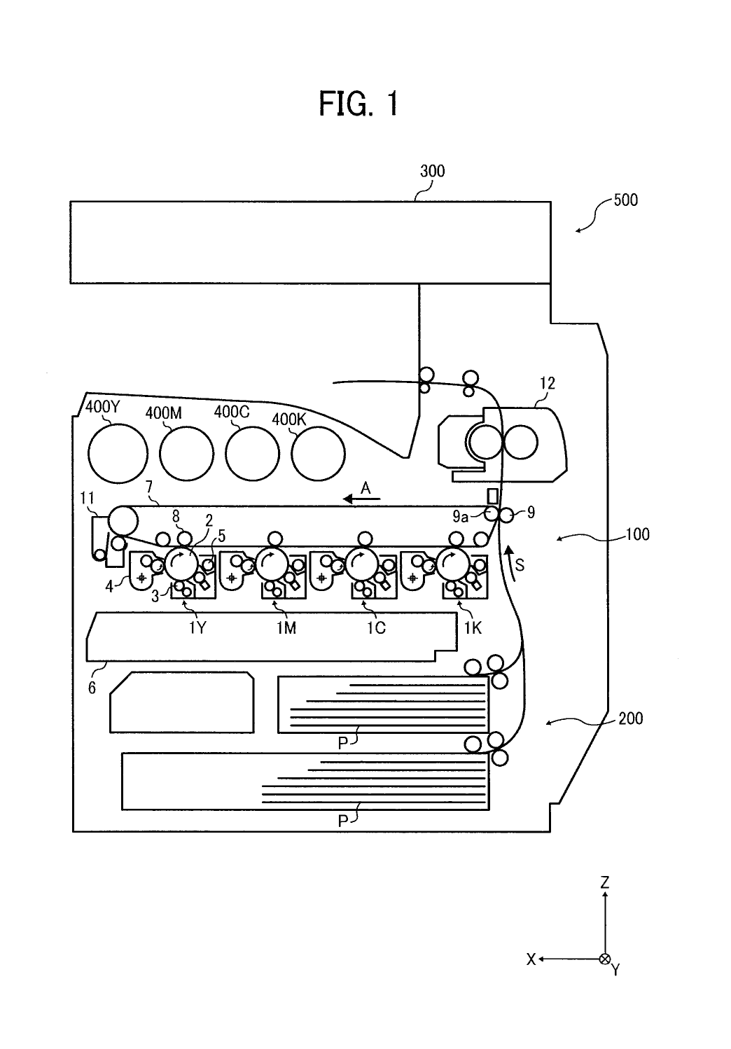

Referring now to the drawings, wherein like reference numerals designate identical or corresponding parts throughout the several views thereof, and particularly to FIG. 1, a multicolor image forming apparatus according to an embodiment of the present invention is described.

FIG. 1 is a schematic diagram that illustrates a configuration of an image forming apparatus 500 according to the present embodiment.

The image forming apparatus 500 can be, for example, a copier and includes a body or printer unit 100, a sheet-feeding table or sheet feeder 200, and a scanner 300 provided above the printer unit 100. The printer unit 100 includes four process cartridges 1Y, 1M, 1C, and 1K, an intermediate transfer belt 7 serving as an intermediate transfer member that rotates in the direction indicated by arrow A shown in FIG. 1 (hereinafter “belt travel direction”), an exposure unit 6, and a fixing device 12.

It is to be noted that the suffixes Y, M, C, and K attached to each reference numeral indicate only that components indicated thereby are used for forming yellow, magenta, cyan, and black images, respectively. The four process cartridges 1 have a similar configuration except the color of toner used therein, and hereinafter the suffixes Y, M, C, and K may be omitted when color discrimination is not necessary.

Each process cartridge 1 includes a photoreceptor 2, a charging member 3, a development device 4, and a drum cleaning unit 5, and these components are housed in a common unit casing, thus forming a modular unit. The process cartridge 1 can be installed in the body 100 of the image forming apparatus 500 and removed therefrom by releasing a stopper.

The photoreceptor 2 rotates clockwise in FIG. 1 as indicated by arrow shown therein. The charging member 3 can be a charging roller. The charging member 3 is pressed against a surface of the photoreceptor 2 and rotates as the photoreceptor 2 rotates. In image formation, a high-voltage power source applies a predetermined bias voltage to the charging member 3 so that the charging member 3 can electrically charge the surface of the photoreceptor 2 uniformly. Although the process cartridge 1 according to the present embodiment includes the charging member 3 that contacts the surface of the photoreceptor 2, alternatively, contactless charging members such as corona charging members may be used instead.

The exposure unit 6 exposes the surface of the photoreceptor 2 according to image data read by the scanner 300 or acquired by external devices such as computers, thereby forming an electrostatic latent image thereon. Although the exposure unit 6 in the configuration shown in FIG. 1 employs a laser beam scanning method using a laser diode, other configurations such as those using light-emitting diode (LED) arrays may be used.

The drum cleaning unit 5 removes toner remaining on the photoreceptor 2 after the photoreceptor 2 passes by a position facing the intermediate transfer belt 7.

The four process cartridges 1 form yellow, cyan, magenta, and black toner images on the respective photoreceptors 2. The four process cartridges 1 are arranged parallel to the belt travel direction indicated by arrow A. The toner images formed on the respective photoreceptors 2 are transferred therefrom and superimposed sequentially one on another on the intermediate transfer belt 7 (primary-transfer process). Thus, a multicolor toner image is formed on the intermediate transfer belt 7.

In FIG. 1, primary-transfer rollers 8 serving as primary-transfer members are provided at positions facing the respective photoreceptors 2 via the intermediate transfer belt 7. Receiving a primary-transfer bias from a high-voltage power source, the primary-transfer roller 8 generates a primary-transfer electrical field between the photoreceptor 2 and the primary-transfer roller 8. With the primary-transfer electrical field, the toner images are transferred from the respective photoreceptors 2 onto the intermediate transfer belt 7. As one of multiple tension rollers around which the intermediate transfer belt 7 is looped is rotated by a driving roller, the intermediate transfer belt 7 rotates in the belt travel direction indicated by arrow A shown in FIG. 1. While the toner images are superimposed sequentially on the rotating intermediate transfer belt 7, the multicolor toner image is formed thereon.

Among the multiple tension rollers, a tension roller 9a is disposed downstream from the four process cartridges 1 in the belt travel direction indicated by arrow A and presses against a secondary-transfer roller 9 via the intermediate transfer belt 7, thus forming a secondary-transfer nip therebetween. The tension roller 9a is also referred to as a secondary-transfer facing roller 9a. A predetermined voltage is applied to the secondary-transfer roller 9 or the secondary-transfer facing roller 9a to generate a secondary-transfer electrical field therebetween. Sheets P fed by the sheet feeder 200 are transported in the direction indicated by arrow S shown in FIG. 1 (hereinafter “sheet conveyance direction”). When the sheet P passes through the secondary-transfer nip, the multicolor toner image is transferred from the intermediate transfer belt 7 onto the sheet P by the effects of the secondary-transfer electrical field (secondary-transfer process).

The fixing device 12 is disposed downstream from the secondary-transfer nip in the sheet conveyance direction. The fixing device 12 fixes the multicolor toner image with heat and pressure on the sheet P that has passed through the secondary-transfer nip, after which the sheet P is discharged outside the image forming apparatus 500.

Meanwhile, a belt cleaning unit 11 removes toner remaining on the intermediate transfer belt 7 after the secondary-transfer process.

Additionally, toner bottles 400Y, 400M, 400C, and 400K containing respective color toners are provided above the intermediate transfer belt 7. The toner bottles 400 are removably installed in the body 100. Toner is supplied from the toner bottle 400 by a toner supply device to the development device 4 for the corresponding color.

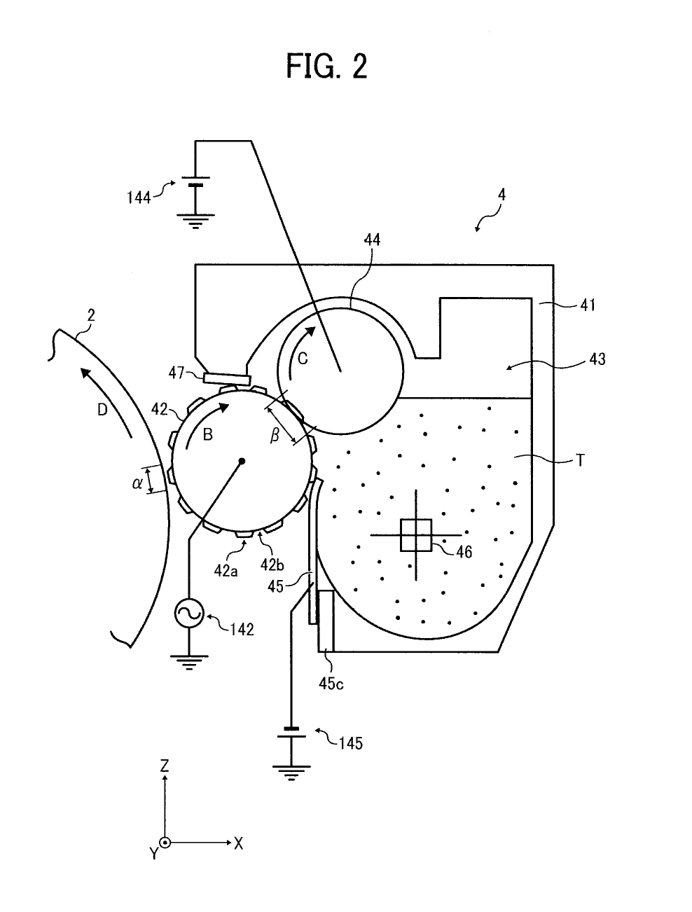

FIG. 2 is a schematic end-on axial view of the development device 4 according to the present embodiment, as viewed from the back of the paper on which FIG. 1 is drawn. It is to be noted that reference character T shown in FIG. 2 represents toner or toner particles.

As shown in FIG. 2, the development device 4 includes a development casing 41, inside which a development roller 42 serving as a developer bearer, a supply roller 44, a doctor blade 45 serving as a developer regulator, and a paddle 46 are provided.

The development casing 41 is open on the side facing the photoreceptor 2 to partly expose the development roller 42 so that the development roller 42 faces the photoreceptor 2 in a development range α. A predetermined clearance (development gap) is secured between the development roller 42 and the photoreceptor 2 that rotates in the direction indicated by arrow D in FIG. 2. The development roller 42 has surface unevenness. That is, multiple projections 42a and recesses 42b are formed on the surface of the development roller 42.

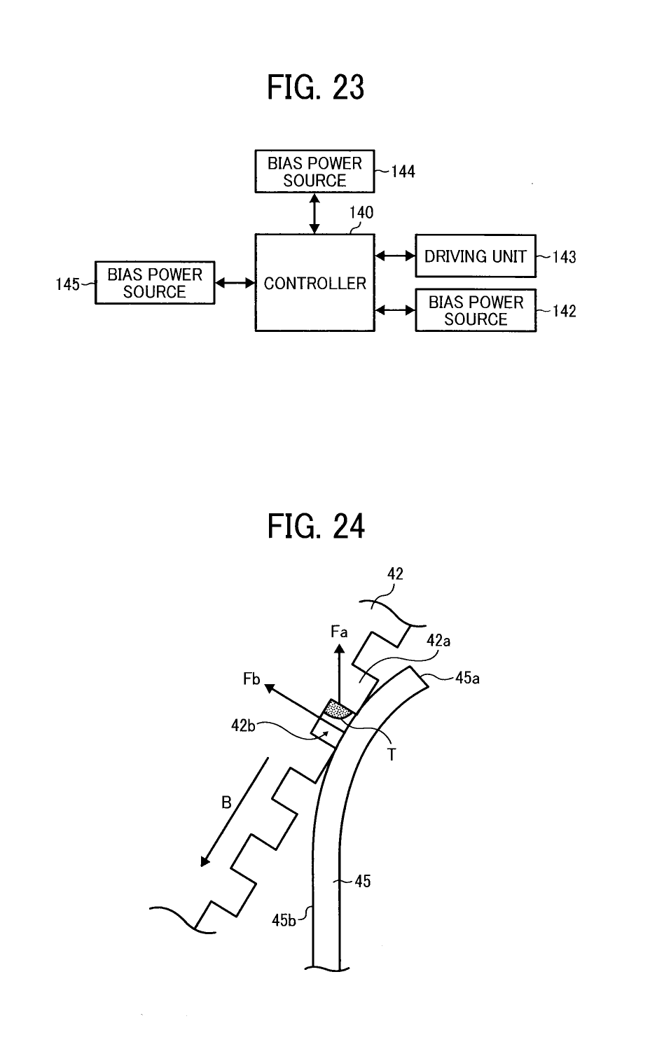

For image development, the development roller 42 rotates in the direction (i.e., normal direction) indicated by arrow B shown in FIG. 2, driven by a driving unit 143 (shown in FIG. 23) such as a motor. Additionally, a development bias power source 142 is connected to the development roller 42. The development bias power source 142 applies alternating voltage (AC) to the development roller 42. The alternating voltage includes a first voltage to direct toner from the development roller 42 to the photoreceptor 2 and a second voltage to direct toner from the photoreceptor 2 to the development roller 42 for developing the latent image with toner transported to the development range α. Thus, in the present embodiment, the development gap is secured between the development roller 42 and the photoreceptor 2, and alternating voltage is applied to the development roller 42 for image development, which is a so-called “contactless AC jumping method”. Contactless image development is advantageous in that the surface unevenness of the development roller 42 is less likely to make the image density uneven, and use of alternating voltage can enhance such effects. Thus, image quality can improve.

The supply roller 44, the doctor blade 45, and the entrance seal 47 contact the development roller 42.

The supply roller 44 supplies toner T contained in a toner containing chamber 43 to the development roller 42 in a supply nip β while collecting toner T that is not used in the development range α from the development roller 42. Thus, the supply roller 44 serves as a developer collecting member. In the configuration shown in FIG. 2, the supply roller 44 is disposed above the toner containing chamber 43 or in an upper portion of the toner containing chamber 43 such that the supply roller 44 is positioned, at least partly, above the level (surface) of toner T inside the toner containing chamber 43 when the paddle 46 is motionless. Further, an area downstream from the supply nip β in the direction indicated by arrow C (hereinafter “direction C”) shown in FIG. 2, in which the supply roller 44 rotates, is positioned above the level of toner T. The supply roller 44 rotates in the direction C, driven by a driving motor. That is, the supply roller 44 and the development roller 42 rotate in the opposite directions in the contact area therebetween.

A bias power source 144 serving as an electrical field generator is connected to the supply roller 44. Although alternating voltage is applied to the development roller 42, the bias voltage applied from the bias power source 144 to the supply roller 44 is a direct current (DC) voltage in the polarity opposite the polarity of normal charge of toner. In the first embodiment, toner is charged to have negative (minus) polarity, and the supply bias is a DC voltage in positive (plus) polarity. Thus, the voltage applied to not the development roller 42 but the supply roller 44 has the polarity (positive polarity) opposite the polarity of normal charge of toner. With this configuration, an electrical field in the direction for attracting toner toward the supply roller 44 can be formed in the supply nip β, thus facilitating resetting of toner on the development roller 42 (removal of toner from the development roller 42). Even when the electrical field for attracting toner to the supply roller 44 is generated in the supply nip β, a sufficient amount of toner can be supplied to the development roller 42 because a large amount of toner can be carried from the toner containing chamber 43 to the supply nip β.

It is to be noted that, depending on the specification of the development device 4, the bias power source 144, which requires a separate DC power source, may be omitted, thereby reducing the cost. Additionally, in the configuration without the bias power source 144, toner that has passed through the development range may be electrically discharged by the entrance seal 47. In this case, a bias may be applied to the entrance seal 47 for facilitating electrical discharge.

The supply roller 42 is pressed against the development roller 42 to bite into the surface of the development roller 41. The amount by which the supply roller 44 bites into the surface of the development roller 42, which can be expressed as the radius of the development roller 42 plus the radius of the supply roller 44 minus the distance between the axes of the development roller 42 and the supply roller 44, is greater than the height of the projections 42a of the development roller 42. With this configuration, toner can be removed from the recesses 42b and be reset properly. It is to be noted that the above-described amount should not be too large because toner may be pushed in the recesses 42b and agglomerate or coagulate if the above-described amount is extremely large relative to the height of the projections 42a.

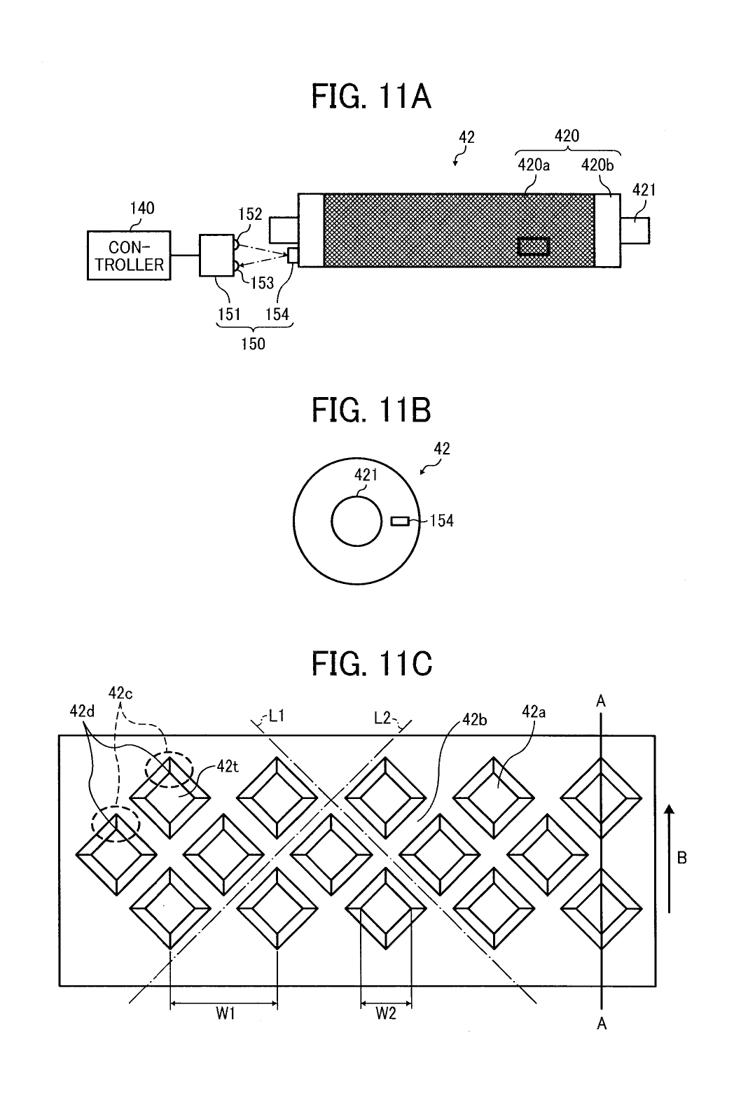

The doctor blade 45 is pressed against the development roller 42 with a pressing force of about 10 N/m to 100 N/m at a position downstream from the supply nip β and upstream from the development range α in the direction B (hereinafter also “normal direction B”) in which the development roller 42 rotates in image development. In the contact portion between the doctor blade 45 and the development roller 42, the doctor blade 45 levels off toner, that is, scrapes off toner from top faces 42t (shown in FIG. 11C) of the projections 42a. Thus, the doctor blade 45 adjusts the amount of toner carried on the surface of the development roller 42 downstream from the doctor blade 45 and gives electrical charges to the toner through triboelectric charging. The contact between the doctor blade 45 and the development roller 42 can be either “end contact or edge contact” meaning that an end portion (free end side) of the doctor blade 45 contacts the development roller 42, or “planar contact” meaning that a part of the face of the doctor blade 45 at a position between the free end and the base end contacts the development roller 42.

More specifically, in case of the end contact, a tip of the doctor blade 45 up to about 1 mm contacts the development roller 42. The end contact is advantageous in that the doctor blade 45 can scrape off toner from the top face 42t of the projections 42a, and that only toner contained in the recesses 42b can be transported to the development range α. Thus, the amount of toner conveyed to the development range α can be kept constant. It is preferable that the end portion of the doctor blade 45 contacts the development roller 42 in the direction counter (hereinafter “counter contact”) to the direction B in which the development roller 42 rotates in image development. The end of the doctor blade 45 in the counter contact is advantageous for scraping off toner from the top faces 42t of the projections 42a. Thus, only toner contained in the recesses 42b can be transported to the development range α.

Additionally, a bias power source 145 is connected to the doctor blade 45. For example, the bias power source 145 applies the doctor blade 45 a direct current (DC) voltage within a range of the alternating voltage applied to the development roller 42±200 V to facilitate triboelectric charging of toner. The voltage value may be adjusted in accordance with usage conditions. Specifically, under low humidity and low temperature conditions, the bias power source 145 applies the doctor blade 45 a voltage capable of generating, between the development roller 42 and the doctor blade 45, an electrical field in the direction for attracting toner on the development roller 42 toward the doctor blade 45. Although alternating voltage is applied to the development roller 42, the bias voltage applied to the doctor blade 45 is a DC voltage in the polarity opposite the polarity of normal charge of toner. In the first embodiment, toner is charged to have negative (minus) polarity, and the bias voltage is a DC voltage in positive (plus) polarity. Under low humidity and low temperature conditions, the amount of toner supplied by the supply roller 44 to the development roller 42 is greater, making it difficult for the doctor blade 45 to scrape off toner from the top faces 42t of the projections 42a sufficiently. Consequently, an amount of toner (hereinafter “toner amount M”) carried on a unit area (hereinafter “roller unit area A”) of the development roller 42 (WA) downstream from the doctor blade 45 can be greater, that is, M/A is not kept constant. Therefore, under low humidity and low temperature conditions, the electrical field in the direction for attracting toner on the development roller 42 toward the doctor blade 45 is generated between the development roller 42 and the doctor blade 45, thereby electrostatically moving a part of toner carried on the development roller 42 toward the doctor blade 45. This configuration can reduce the amount of toner to be scraped off by the doctor blade 45, and the doctor blade 45 can fully remove toner from the top faces 42t of the projections 42a. Thus, fluctuations in the toner amount M carried on the roller unit area A (WA) can be reduced.

The entrance seal 47 contacts the development roller 42 downstream from the development range α and upstream from the supply nip β in the direction B in which the development roller 42 rotates. The entrance seal 47 seals clearance between the development casing 41 and the development roller 42, thereby preventing toner from scattering outside the development casing 41. The entrance seal 47 contacts the development roller 42 with a low pressure to allow toner on the development roller 42 to pass through the contact area between the development roller 42 and the entrance seal 47.

The paddle 46 is provided in the toner containing chamber 43 for containing toner and is rotatable relative to the development casing 41.

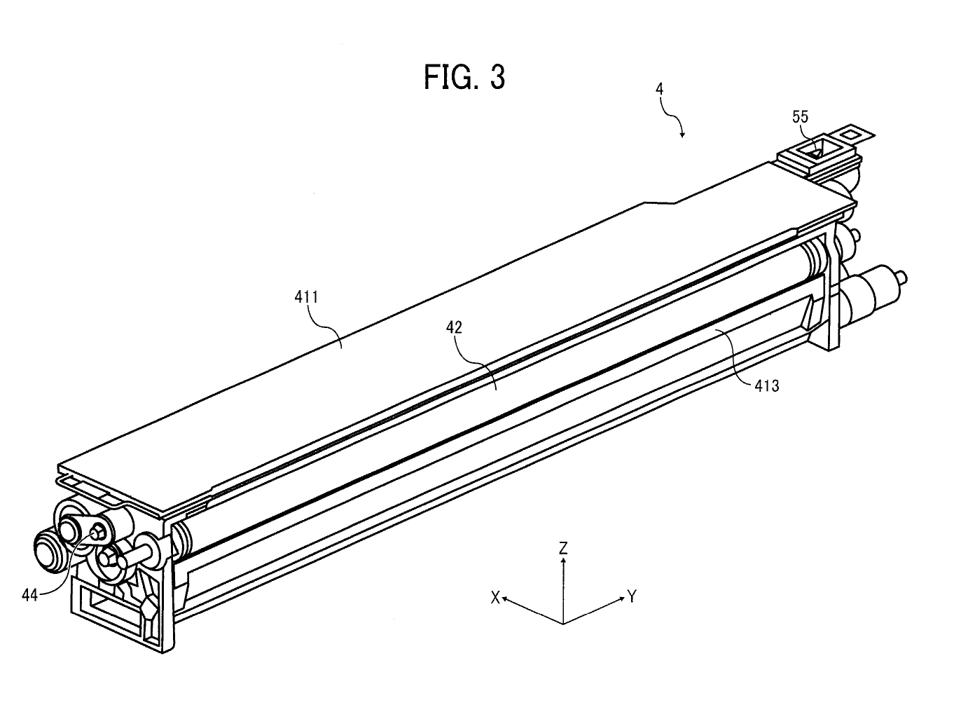

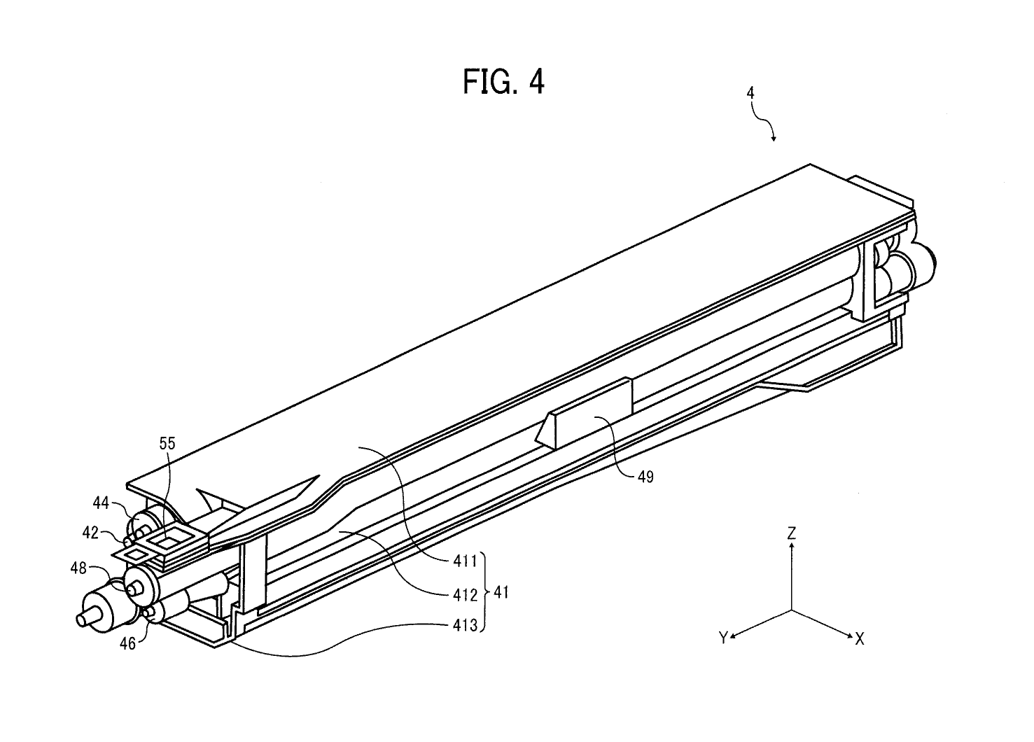

FIGS. 3 and 4 are perspective views of the development device 4 as viewed from above obliquely in different directions.

Referring to FIG. 4, an upper case 411, an intermediate case 412, and a lower case 413 together form the development casing 41 of the development device 4. The intermediate case 412 forms the toner containing chamber 43, and a toner supply inlet 55 communicating with the toner containing chamber 43 is formed in the upper case 411. Additionally, a toner amount detector 49 is provided to the intermediate case 412 to detect the mount of toner remaining inside the toner containing chamber 43.

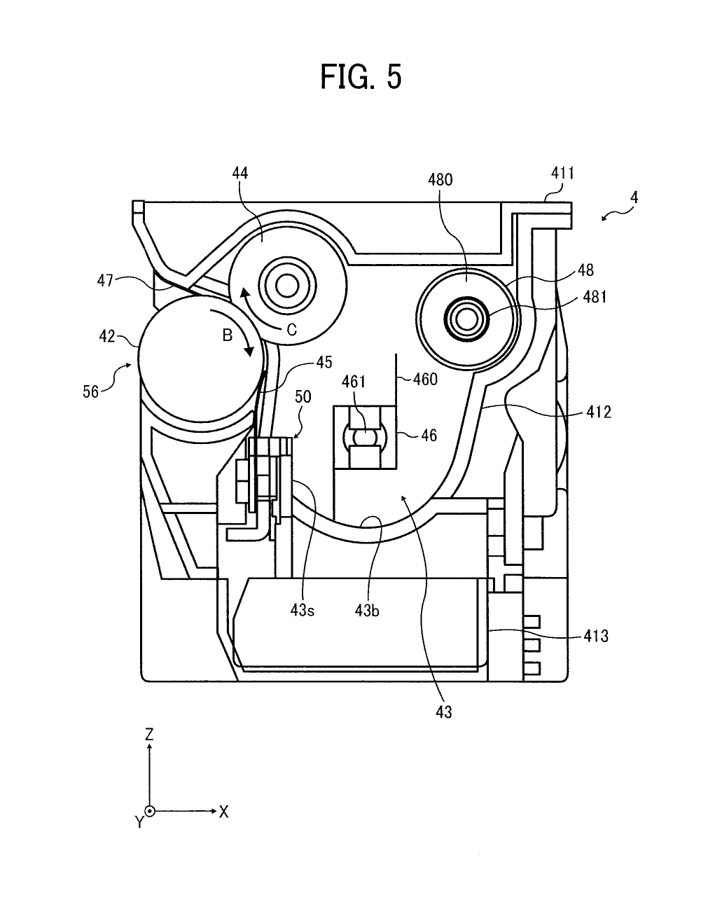

FIG. 5 is an end-on axial view of the development device 4 as viewed in the same direction as in FIG. 2. As shown in FIG. 5, the development roller 42, the doctor blade 45, and the paddle 46 are provided in the intermediate case 412. The intermediate case 412 further contains a supply screw 48. The entrance seal 47 is provided to the upper case 411.

As shown in FIG. 5, an inner bottom face 43b of the toner containing chamber 43 is shaped into an arc confirming to the direction of rotation of the paddle 46 to prevent paddle blades 460 from being caught on the inner bottom face 43b of the toner containing chamber 43 while the paddle 46 rotates.

The inner bottom face 43b is continuous with a side wall 43s standing vertically on the side of the development roller 42. A top face of the side wall 43s parallels a plane X-Y and is horizontal toward the development roller 42. A height of the top face of the side wall 43s is similar to or slightly lower than a center of a paddle shaft 461, thus forming a step 50.

A distance between the side wall 43s and the paddle shaft 461 is shorter than a distance between the inner bottom face 43b and the paddle shaft 461. Therefore, the paddle blades 460, which slidingly contact the inner bottom face 43b, can deform more when the paddle blades 460 contact the side wall 43s. Then, the paddle blade 460 is released and flipped up when the distal end of the paddle blade 460 reaches the step 50. As the paddle blades 460 thus move, toner can be flipped up, agitated, and transported.

The step 50 has a horizontal face parallel to X-Y plane and extends in the longitudinal direction of the development device 4 (Y-axis direction in the drawings). It is to be noted that, although the step 50 is present over the entire width in the first embodiment, the step 50 may extend partly inside the development device 4 as long as the paddle blades 460 can be flipped up.

The supply screw 48 includes a screw shaft 481 and a spiral blade 480 fixed to the screw shaft 48. The supply screw 48 is rotatable upon the screw shaft 481, and the screw shaft 481 parallels the longitudinal direction of the development device 4 (Y-axis direction in the drawings).

An axial end portion of the supply screw 48 is positioned beneath the toner supply inlet 55 (shown in FIGS. 3 and 4) formed in a longitudinal end portion of the development device 4. As the supply screw 48 rotates, the spiral blade 480 transports toner supplied through the toner supply inlet 55 to a longitudinal center of the development device 4.

Additionally, an inner face (lower face) of the upper case 411 is curved in conformity to the shape of the supply roller 44, and a clearance of about 1.0 mm is provided between the curved inner face of the upper case 411 and the supply roller 44.

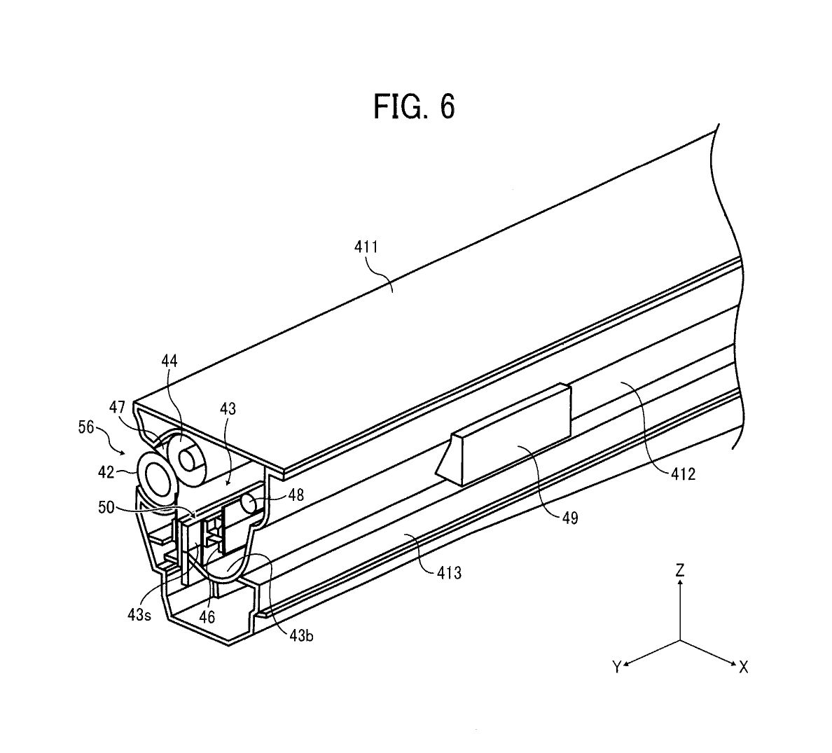

FIG. 6 is an enlarged perspective view of the development device 4 using a Z-X cross-sectional view.

An interior of the development device 4 communicates with the outside through an opening 56 formed in the development casing 41, extending in the longitudinal direction of the development device 4 (Y-axis direction in the drawings). The development roller 42 is partially exposed through the opening 56.

The entrance seal 47 can be constructed of a plastic sheet such as Mylar® (registered trademark of DuPont) and substantially rectangular. An end on its shorter side (perpendicular to the axial direction of the development roller 42) is bonded to the rim of the upper case 411, and other end is free. The free end of the entrance seal 47 projects inwardly in the development device 4 and is disposed to contact the development roller 42. It is preferable that only a tip (up to 1 mm) of the entrance seal 47 contacts the development roller 42.

Next, the development roller 42 is described in further detail below.

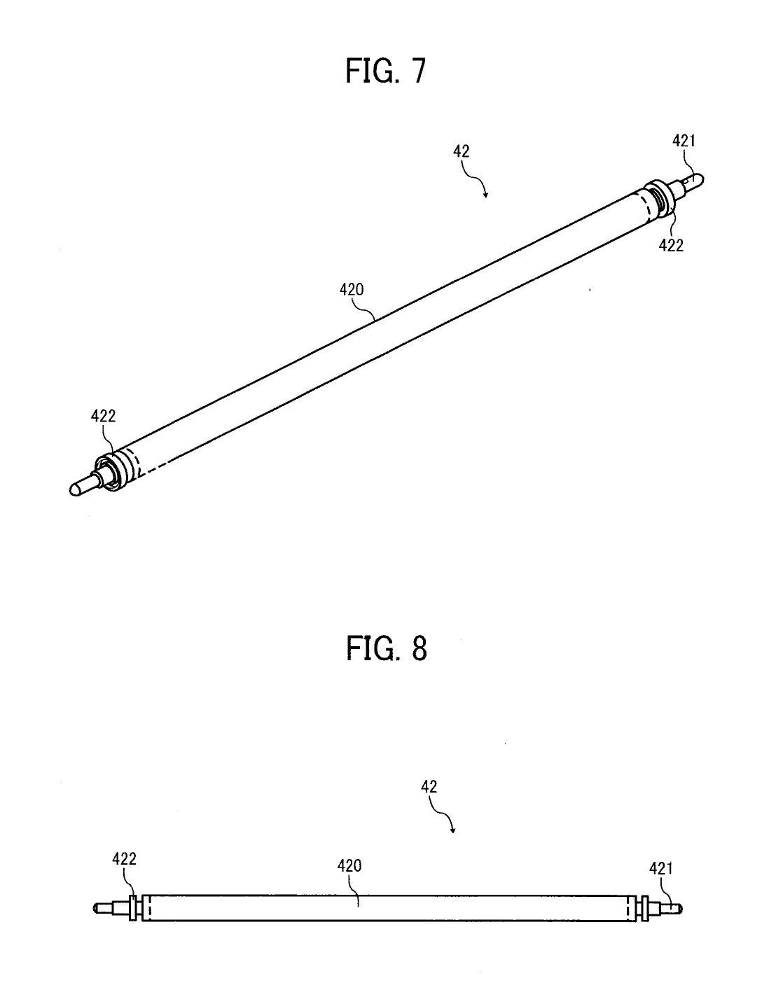

FIG. 7 is a perspective view of the development roller 42, and FIG. 8 is a side view of the development roller 42.

As shown in FIGS. 7 and 8, the development roller 42 includes a roller shaft 421, a roller-shaped toner carrying sleeve 420, and spacers 422 fixed to either axial end portion of the roller shaft 421, outside the toner carrying sleeve 420. Additionally, the spacers 422 provided to either axial end portion contact the surface of the photoreceptor 2, and the distance between the surface of the toner carrying sleeve 420 and the surface of the photoreceptor 2 (i.e., development gap) in the development range α can be kept constant.

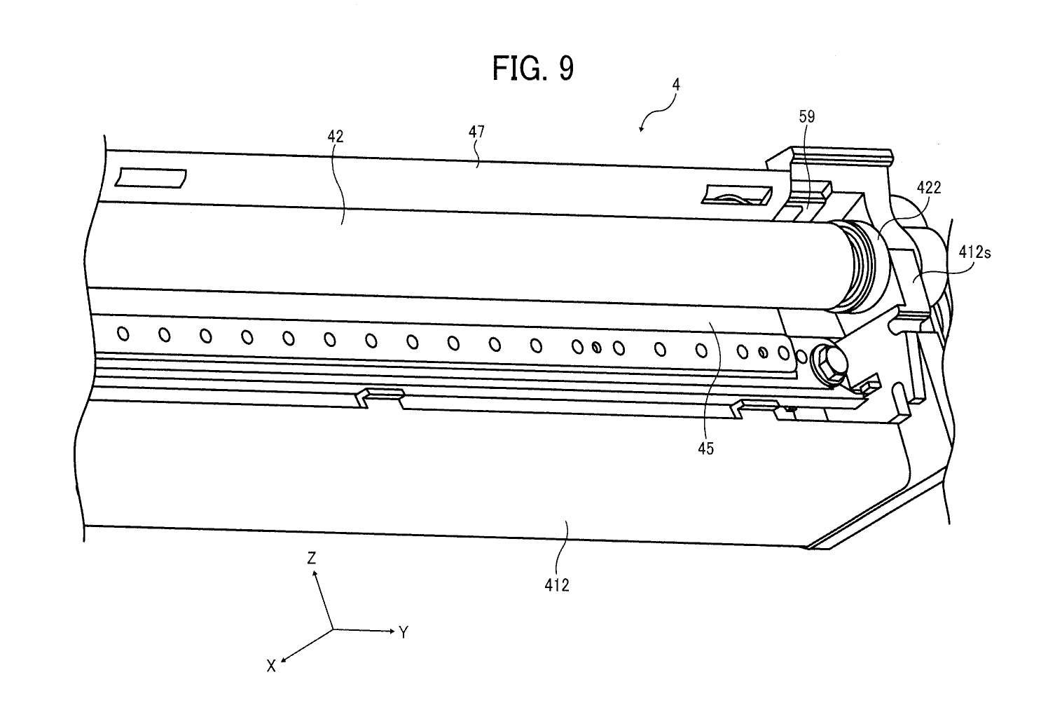

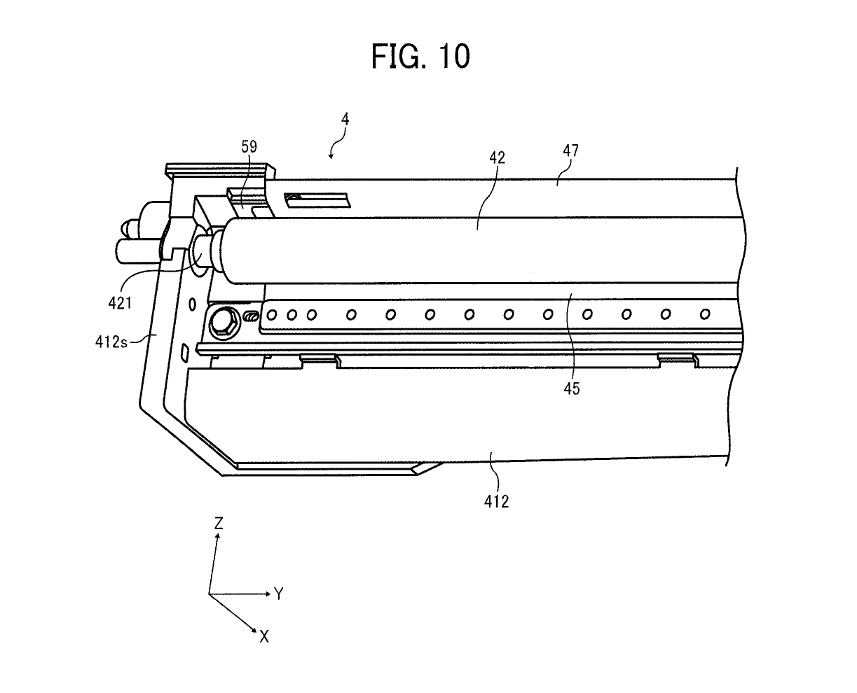

FIG. 9 is an enlarged perspective view illustrating an axial end portion of the development device 4 (on the distal side or right side in FIG. 3), from which the lower case 413 is removed. FIG. 10 is an enlarged perspective view illustrating the other end portion the development device 4, from which the lower case 413 is removed. In FIG. 10, the spacers 422 are omitted for simplicity.

Both axial end portions of the roller shaft 421 are rotatably supported by side walls 412s (shown in FIG. 10) of the intermediate case 412 and parallel to the Y-axis direction in the drawings.

Additionally, lateral end seals 59 are bonded to a part of the intermediate case 412, inside the spacers 422 in the axial direction of the development roller 42. The lateral end seals 59 are disposed to overlap with the end portions of the doctor blade 45 that contacts the development roller 42 in the axial direction. The lateral end seals 59 are designed to prevent leakage of toner at the longitudinal ends of the opening 56 formed in the development casing 41.

FIG. 11A schematically illustrates an exterior of the development roller 42, FIG. 11B is an end-on axial view of the development roller 42, and FIG. 11C is an enlarged view illustrating an area R (shown in FIG. 11A) on the surface of the development roller 42.

The toner carrying sleeve 420 can be constructed of aluminum alloy, iron alloy, or the like and, as shown in FIG. 11A, includes a grooved range 420a and smooth surface ranges 420b different in surface structure.

The grooved range 420a is a portion including an axial center of the development roller 42, and the surface thereof is processed to have irregularities to carry toner thereon properly. In the present embodiment, surface unevenness can be formed through rolling, and the projections 42a are enclosed by first and second spiral grooves L1 and L2 winding in different directions. In the development roller 42 in the present embodiment, for example, a pitch width W1 of the projections 42a in the axial direction can be 80 μm, and an axial length W2 of the top face 42t of the projection 42a is 40 μm. A depth W3, which is a height from the recess 42b to the top face 42t of the projection 42a, can be 10 μm. The size of the pitch width W1, the axial length W2, and the depth W3 are not limited to the above-described values.

It is preferred that the toner carrying sleeve 420 has a surface layer constructed of a material suitable for normal charging of toner. Even if low-charge toner particles are present due to filming, low-charge toner particles can be pushed out by jumping toner and charged at positions free of filming among the projections 42a and the recesses 42b. Thus, the amount of low-charge toner particles can be reduced, and image density can become constant.

When the surface layer of the toner carrying sleeve 420 is harder than the doctor blade 45, the projections 42a of the development roller 42 are not easily abraded by the doctor blade 45, and a capacity (volume) of the recess 42b enclosed by the projections 42a and the doctor blade 45 does not change easily. However, making the doctor blade 45 harder than the surface of the development roller 42 is advantageous for preventing abrasion of the doctor blade 45 by the development roller 42, thereby securing, for long time, capability of the doctor blade 45 to scrape off developer from the top face 42t of the projection 42a of the development roller 42.

Additionally, it is preferable that the height of the projection 42a be greater than the weight average particle size of toner. With this configuration, selection of particle size can be inhibited because toner of average particle size can be contained inside the recess 42b. Accordingly, the toner amount M on the roller unit area A (M/A) downstream from the doctor blade 45 can be stable.

Additionally, the top face 42t of the projection 42a is diamond-shaped and has two pairs of parallel sides both oblique to the direction B in which the development roller 42 rotates as shown in FIG. 11C. In this configuration, the direction in which the doctor blade 45 slidingly contacts the projections 42a can be oblique to the two pairs of parallel sides of the top face 42t of each projection 42a. Accordingly, toner is not easily compressed in an area 42c (shown in FIG. 11 C) adjacent to a corner 42d of the projection 42a (upstream wall of the recess 42b) in the direction B in which the development roller 42 rotates in image development. In the present embodiment, the sides of the diamond-shaped top face 42t of each projection 42a can be at an angle of 45° to the direction B in which the development roller 42 rotates, for example.

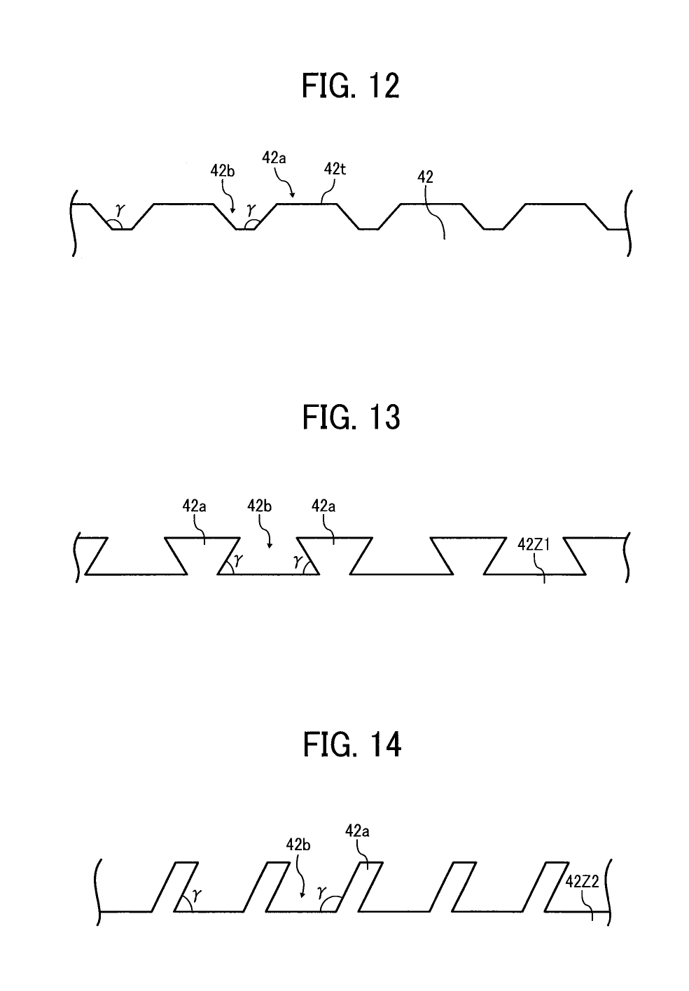

FIG. 12 is a cross-sectional view of the development roller 42 according to the present embodiment along line A-A shown in FIG. 11C. FIGS. 13 and 14 illustrate comparative development rollers 42Z1 and 42Z2.

As shown in FIG. 12, in the present embodiment, angles γ each formed by the side face of the projection 42a and the bottom face of the recess 42b are equal to or greater than 90°. If the angles γ formed by the projections 42a and the recesses 42b are smaller than 90° as in the comparative development roller 42Z1 shown in FIG. 13, the probability that the supply roller 44 contacts the recesses 42b entirely can decrease. If some of the angles γ formed by the projections 42a and the recesses 42b are smaller than 90° as in the another comparative development device 42Z2 shown in FIG. 14, the probability that the supply roller 44 contacts the recesses 42b entirely can decrease similarly. Consequently, removal of toner by the supply roller 44 can be degraded.

By contrast, when the angle γ between the side face of the projection 42a and the bottom face of the recess 42b is equal to or greater than γ as in the present embodiment shown in FIG. 12, the probability of contact between the supply roller 44 and the development roller 42 increases. Thus, resetting of toner by the supply roller 44 can increase.

Additionally, when the angle γ is 90° or greater, the supply roller 44 can better remove toner particles in the area 42c (shown in FIG. 11C) adjacent to the corner 42d of the projection 42a (adjacent to the upstream wall of the recess 42b in the direction B), thus facilitating replacement of toner particles. Since toner in the area 42c is replaced, compression force is not repeatedly applied to specific toner particles, thereby inhibiting coagulation of toner particles.

Next, the supply roller 44 is described in further detail below.

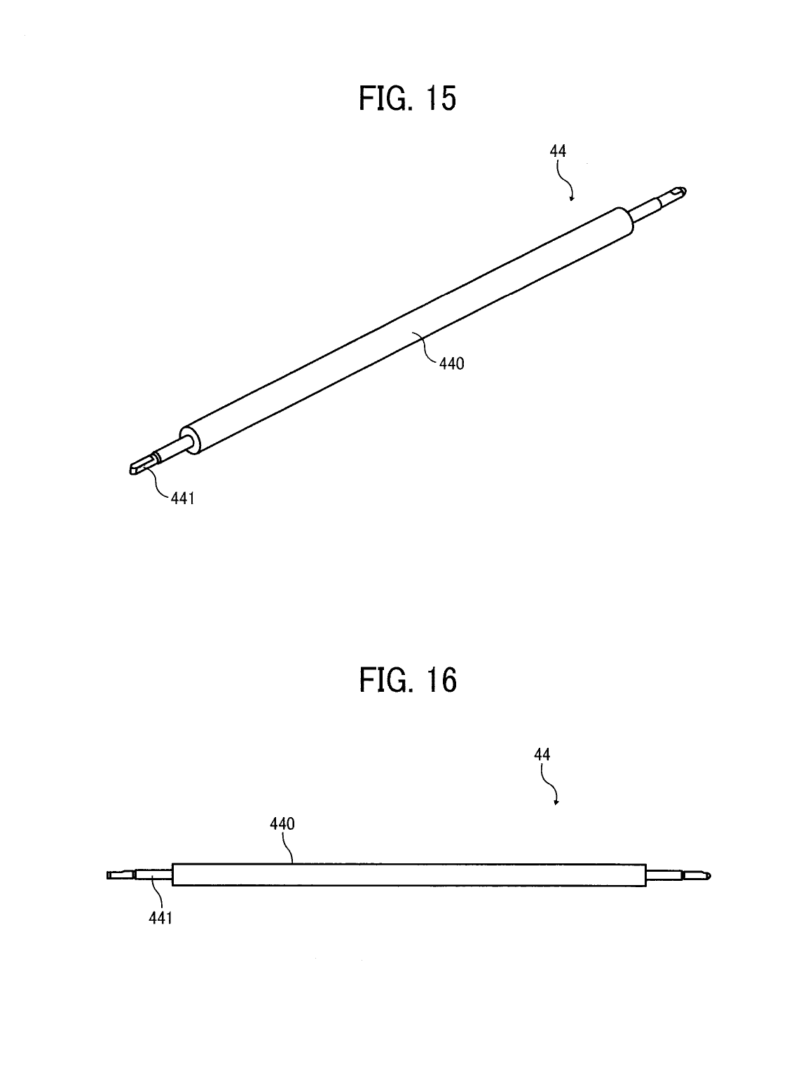

FIG. 15 is a perspective view of the supply roller 44, and FIG. 16 is a side view of the supply roller 44.

The supply roller 44 includes a roller shaft 441 and a supply sleeve 440 constructed of a cylindrical foam member winding around the roller shaft 441. When the supply sleeve 440 is constructed of a foamed material, a number of minute pores are diffused in a surface thereof (sponge surface layer), which contacts the development roller 42. The sponge surface layer of the supply roller 44 can make it easier for the supply roller 44 to reach the bottom of the recess 42b, thus facilitating resetting toner on the development roller 42. The electrical resistance value of the foamed material for the supply sleeve 440 can be within a range from about 10³ Ω to about 10¹⁴ Ω.

Next, the doctor blade 45 is described below.

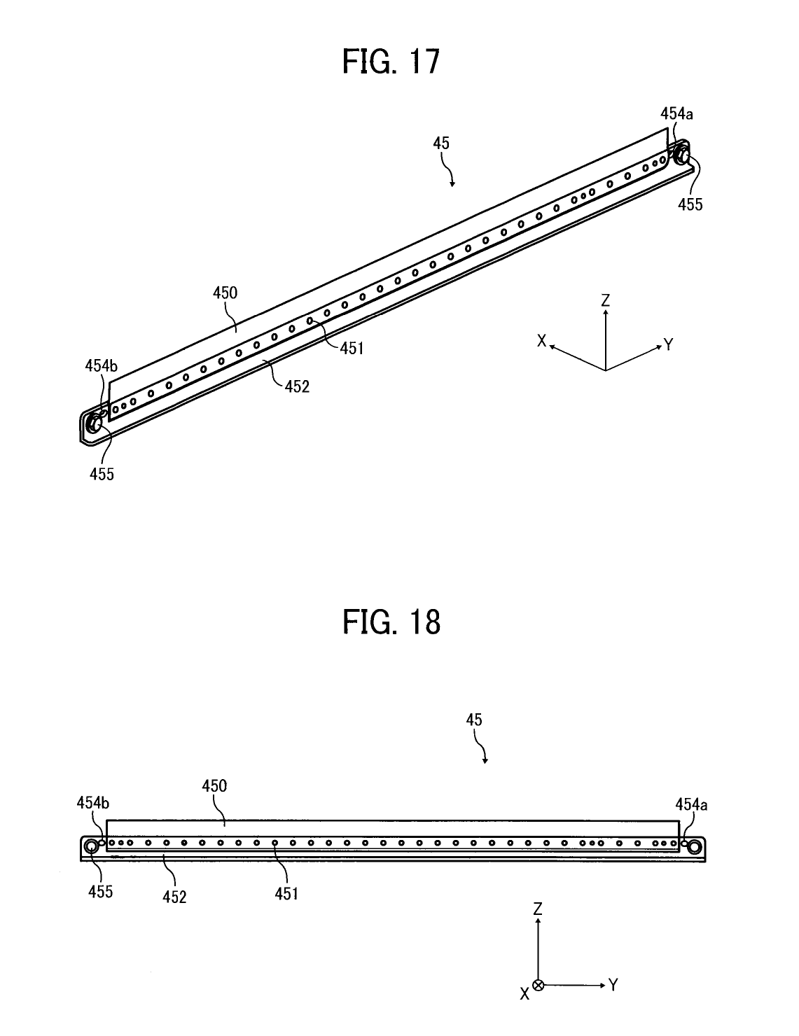

FIG. 17 is a perspective view of the doctor blade 45, and FIG. 18 is a side view of the doctor blade 45.

The doctor blade 45 includes a blade 450 that can be a thin planar metal member and a metal pedestal 452. An end (base end) of the blade 450 is fixed to the pedestal 452. For example, the blade 450 can be a metal leaf spring constructed of SUS304CSP or SUS301CSP (JIS standard); or phosphor bronze. The distal end (free end) of the blade 450 can be in contact with the surface of the development roller 42 with a pressure of about 10 N/m to 100 N/m, forming a regulation nip. While adjusting the amount of toner passing through the regulation nip, the blade 450 applies electrical charge to toner through triboelectric charging.

Additionally, it is preferred that the blade 450 of the doctor blade 45 be conductive. When the blade 450 is conductive, charge amount of toner having a greater charge amount Q per unit volume M (Q/M) can be reduced, and the charge amount Q of toner per unit volume M can become uniform. Accordingly, toner can be prevented from firmly sticking to the development roller 42.

Additionally, the doctor blade 45 (or a blade 450 shown in FIG. 17) is preferably constructed of a material harder than the surface layer of the development roller 42. When the doctor blade 45 is harder than the surface layer of the development roller 42, abrasion of the doctor blade 45 by the sliding contact with the development roller 42 can be alleviated. With this configuration, the doctor blade 45 can sufficiently scrape off toner from the projections 42a for long time, keeping the amount of toner that has passed by the doctor blade 45 (M/A) at a desired amount.

The blade 450 can be fixed to the pedestal 452 using multiple rivets 451. The pedestal 452 is constructed of a metal material harder than the blade 450. A main positioning pin hole 454a that is substantially circular and a sub-positioning pin hole 454b shaped into an oval are formed in longitudinal end portions of the pedestal 452. A long diameter of the sub-positioning pin hole 454b is oriented to the main positioning pin hole 454a.

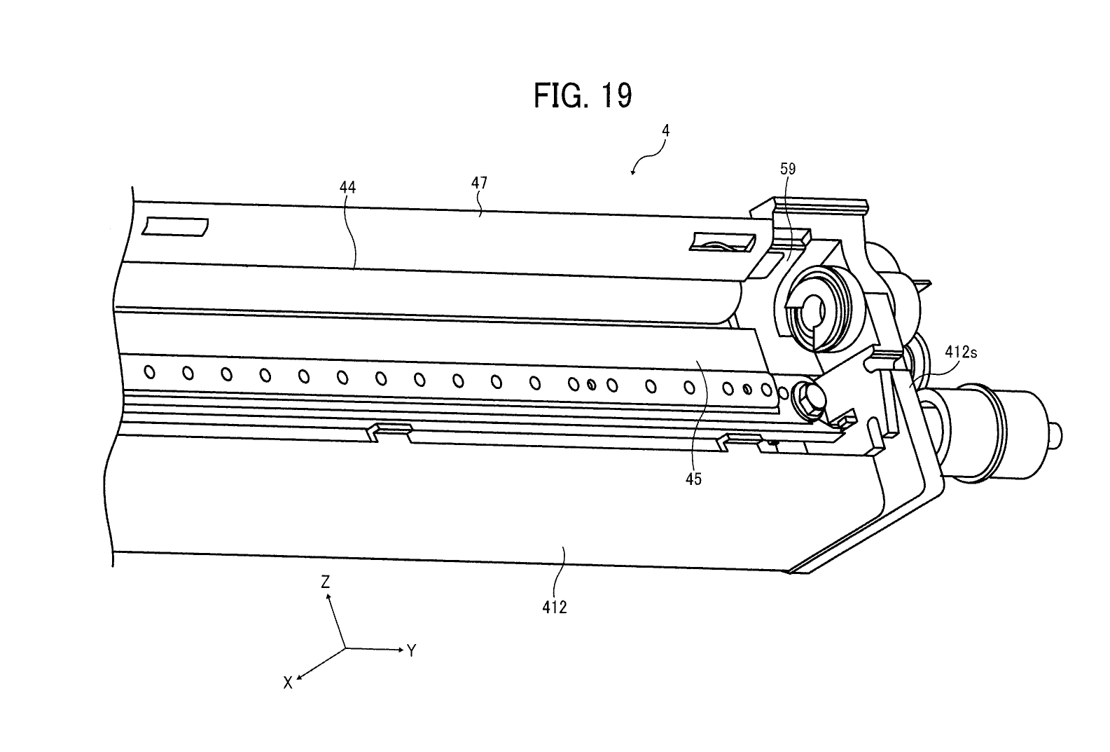

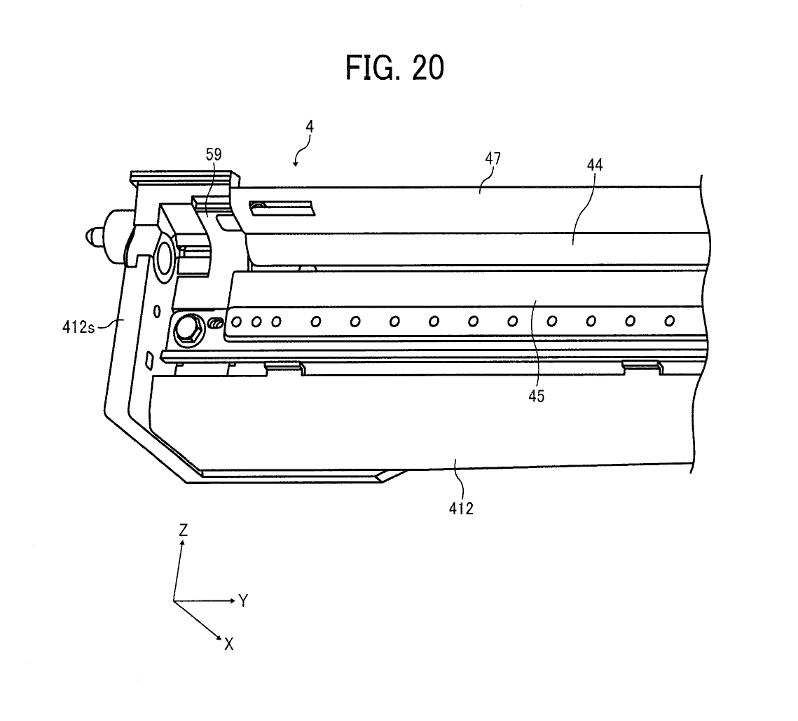

FIG. 19 is an enlarged perspective view illustrating the axial end portion of the development device 4, in which the development roller 42 is omitted. FIG. 20 is an enlarged perspective view of the development device 4 similar to FIG. 10, but the development roller 42 is omitted.

As shown in FIGS. 19 and 20, a main positioning pin provided on a side face of the intermediate case 412 is inserted into the main positioning pin hole 454a formed in the pedestal 452, thereby determining the position of the pedestal 452 relative to the body of the development device 4. Further, a sub-positioning pin provided on the side face of the intermediate case 412 is inserted into the sub-positioning pin hole 454b. Thus, the doctor blade 45 is positioned relative to the intermediate case 412. When the pedestal 452 is screwed to the intermediate case 412 by screws 455 inserted into screw holes positioned in either longitudinal end portion, outside the main positioning pin hole 454a or the sub-positioning pin hole 454b, the doctor blade 45 is fixed to the side face of the intermediate case 412.

When the doctor blade 45 (or the blade 450) is made of metal, toner can be scraped off from the projections 42a of the development roller 42 properly even if the contact portion of the doctor blade 45 with the development roller 42 fluctuates in position or shape due to manufacturing tolerances. This configuration can reduce fluctuations in the toner amount M carried on the roller unit area A (M/A) after toner has passed through the regulation nip.

The paddle 46 is described below.

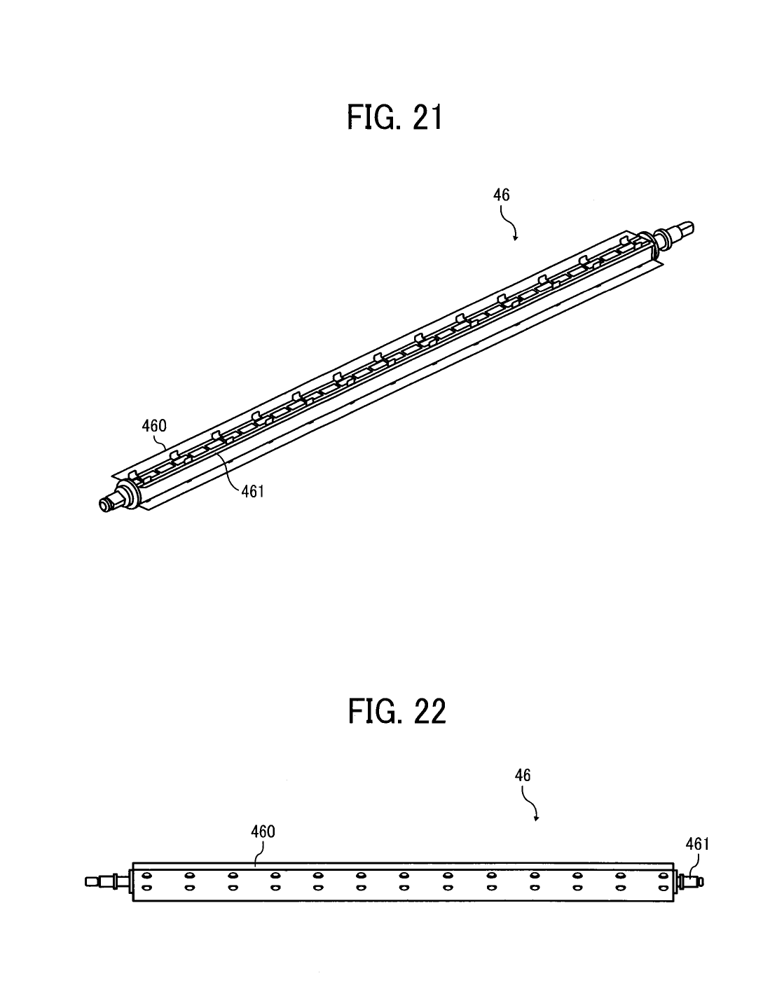

FIG. 21 is a perspective view of the paddle 46, and FIG. 22 is a side view of the paddle 46.

The paddle 46 includes the paddle shaft 461 and the thin paddle blades 460 that are elastic sheet members constructed of plastic sheets, such as Mylar (registered trademark of DuPont). The paddle shaft 461 includes two planar portions facing each other, and the paddle blades 460 are attached to the two planar portions, respectively.

Multiple holes, arranged parallel to the paddle shaft 461, are formed in a base portion of the paddle blade 460, and multiple projections, arranged parallel to the paddle shaft 461, are formed on the paddle shaft 461. The projections of the paddle shaft 461 are inserted into the holes formed in the paddle blade 460 and fixed thereto in thermal caulking. Thus, the paddle blades 460 are fixed to the paddle shaft 461.

FIG. 23 is a control block diagram for controlling the development device 4 according to the present embodiment.

The control black for controlling the development device 4 includes a controller 140 that can be, for example, a micro computer and include a central processing unit (CPU) and storage devices such as a random access memory (RAM), a read-only memory (ROM), and the like. To the controller 140, the development bias power source 142, the driving unit 143 for driving the development roller 42, the bias power source 144 for the supply roller 44, and the bias power source 145 for the doctor blade 45 are connected electrically. The controller 140 is configured to control the respective components according to control programs stored in the RAM.

Next, movement of toner inside the development device 4 is described below.

Toner supplied to the development device 4 from the toner supply inlet 55 (shown in FIG. 4) is transported by the supply screw 48 (shown in FIG. 5) to the toner containing chamber 43 and agitated by the paddle 46. As the paddle 46 rotates, toner is flipped up toward the development roller 42 and the supply roller 44.

The supply roller 44 supplies toner carried thereon to the supply nip β where the supply roller 44 contacts the development roller 42, thereby supplying toner to the surface of the development roller 42, while rotating clockwise in FIG. 2 as indicated by arrow C.

The development roller 42 carries toner on the surface thereof and rotates clockwise in FIG. 2 as indicated by arrow B. Thus, toner is transported to the position facing the doctor blade 45, where toner is scraped off from the top faces 42t of the projections 42a of the development roller 42. Then, only toner retained inside the recesses 42b is transported by the development roller 42. As the development roller 42 rotates further, toner in the recesses 42b is transported to the development range α facing the photoreceptor 2.

In the development range α, a development field is generated by differences in electrical potential between the latent image formed on the photoreceptor 2 and the development bias applied from the development bias power source 142 to the development roller 42. The development field moves toner from the development roller 42 toward the surface of the photoreceptor 2, thus developing the latent image into a toner image.

Toner not used in image development but has passed through the development range α is collected from the surface of the development roller 42 by the supply roller 44, thus initializing the surface of the development roller 42.

Generally, toner held in the recesses 42b formed regularly in the surface of the development roller 42 is not easily removed therefrom. If toner that has passed through the development range α remains on the development roller 42 and passes through the supply nip β, it is possible that the toner firmly adheres to the development roller 42, resulting in toner filming. Toner filming can cause fluctuations in the charge amount of toner carried on the development roller 42 per unit amount, the amount of toner carried on the development roller 42 per unit area, or both, making image density uneven.

In view of the foregoing, in the development device 4 in the present embodiment, the development roller 42 and the supply roller 44 rotate in the opposite directions in the supply nip β. This configuration can increase the difference in linear velocity between the surface of the development roller 42 and that of the supply roller 44 in the supply nip β, and accordingly collection of toner by the supply roller 44 in the supply nip β can be facilitated. The supply roller 44 can collect toner from the development roller 42 after supplying toner to the development roller 42, which is also advantageous for removing toner from the development roller 42. Moreover, when the development roller 42 and the supply roller 44 rotate in the opposite directions, toner collected by the supply roller 44 can be prevented from adhering again to the development roller 42 and collected in the toner containing chamber 43. Since toner can be prevented from being carried over on the development roller 42, firm adhesion of toner to the development roller 42 can be inhibited. Consequently, density unevenness in image development resulting from toner adhesion can be reduced.

For example, in the present embodiment, the ratio of linear velocity of the development roller 42 to that of the supply roller 44 can be 1:0.85, but the linear velocity ratio is not limited thereto.

Additionally, in the configuration shown in FIG. 2, the supply roller 44 is disposed above the toner containing chamber 43 or in an upper portion of the toner containing chamber 43 such that the supply roller 44 is positioned, at least partly, above the level (surface) of toner T inside the toner containing chamber 43 when the paddle 46 is motionless. Further, an area downstream from the supply nip β in the direction C 2, in which the supply roller 44 rotates, is positioned above the level of toner T. In particular, in a comparative configuration in which the area downstream from the supply nip β is filled with toner, it is possible that the toner blocks incoming toner, thus inhibiting collection of toner from the development roller 42 in the supply nip β. By contrast, in the present embodiment, since the area downstream from the supply nip β in the direction C is positioned above the level of toner T as shown in FIG. 2, toner is not present in that area, and collection of toner from the development roller 42 in the supply nip β is not hindered. Thus, collection of toner and initialization of the development roller 42 can be performed efficiently.

Next, toner usable in the present embodiment is described in further detail below.

In the present embodiment, toner having a higher degree of fluidity suitable for high-speed toner conveyance is preferred. For example, toner usable in the present embodiment has a degree of agglomeration of about 40% or smaller under accelerated test conditions, which are described below. The degree of agglomeration under accelerated test conditions means an index representing fluidity of toner. Use of toner whose degree of agglomeration under the above-described accelerated test conditions is 40% or lower can alleviate coagulation of toner in the area 42c shown in FIG. 11C, which is on the upstream side of the recess 42b and downstream side of the projection 42a of the development roller 42 in the direction B.

Specifically, the degree of agglomeration under accelerated test conditions used in this specification can be measured, using a power tester manufactured by Hosokawa Micron Corporation, as follows.

(Measurement Method)

The sample is left in a thermostatic chamber (35±2° C.) for about 24±1 hours. The degree of agglomeration can be measured using the powder tester. Three sieves different in mesh size, for example, 75 μm, 44 μm, and 22 μm are used. The degree of agglomeration can be calculated based on the amount of toner remaining on the sieves using the following formulas:

[Weight of toner remaining on the upper sieve/amount of sample]×100,

[Weight of toner remaining on the middle sieve/amount of sample]×100×3/5, and

[Weight of toner remaining on the lower sieve/amount of sample]×100×1/5

The sum of the above three values is deemed the degree of agglomeration under accelerated test conditions.

As described above, the degree of agglomeration under accelerated test conditions used here is an index obtained from the weight of toner remaining on the three sieves different in mesh size after the sieves are stacked in the order of mesh roughness (with the sieve of largest mesh at the lowest), toner particles are put in the sieve on the top, and constant vibration is applied thereto.

The mean circularity of toner usable in the present embodiment can be 0.90 or greater (up to 1.00).

In the present embodiment, the value obtained from the formula 1 below is regarded as circularity a. The circularity herein means an index representing surface irregularity rate of toner particles. Toner particles are perfect spheres when the circularity thereof is 1.00. As the surface irregularity increases, the degree of circularity decreases.

Circularity a=L₀/L (1)

wherein L₀ represents a circumferential length of a circle having an area identical to that of projected image of a toner particle, and L represents a circumferential length of the projected image of the toner particle.

When the mean circularity is within a range of from 0.90 to 1.00, toner particles have smooth surfaces, and contact areas among toner particles and those between toner particles and the photoreceptor 2 are small, attaining good transfer performance. Further, the toner particle does not have a sharp corner, and torque of agitation of toner inside the development device 4 can be smaller. Accordingly, driving of agitation can be reliable, thus preventing or reducing image failure.

Further, since toner particles forming dots do not include any angular toner particle, pressure can be applied to toner particles uniformly when toner particles are pressed against recording media in image transfer. This can secure transfer of toner particles onto the recording medium.

Moreover, when toner particles are not angular, grinding force of toner particles thereof can be smaller, and scratches on the surfaces of the photoreceptor 2, the charging member 3, and the like can be reduced. Thus, damage or wear of those components can be alleviated.

A measurement method of circularity is described below. Circularity can be measured by a flow-type particle image analyzer FPIA-1000 from SYSMEX CORPORATION.

More specifically, as a dispersant, 0.1 ml to 0.5 ml of surfactant (preferably, alkylbenzene sulfonate) is put in 100 ml to 150 ml of water from which impure solid materials are previously removed, and 0.1 g to 0.5 g of the sample (toner) is added to the mixture. The mixture including the sample is dispersed by an ultrasonic disperser for 1 to 3 min to prepare a dispersion liquid having a concentration of from 3,000 to 10,000 pieces/gl, and the toner shape and distribution are measured using the above-mentioned instrument.

To attain fine dots of 600 dpi or greater, it is preferable that the toner particles have the weight average particle size (D4) within a range from 3 μm to 8 μm. Within this range, the diameter of toner particles is small sufficiently for attaining good microscopic dot reproducibility. When the weight average particle size (D4) is less than 3 μm, transfer efficiency and cleaning performance can drop.

By contrast, when the weight average particle size (D4) is greater than 8 μm, it is difficult to prevent scattering of toner around letters or thin lines in output images. Additionally, the ratio of the weight average particle diameter (D4) to the number average particle diameter (D1) is within a range of from 1.00 to 1.40 (Dv/Dn). As the ratio (D4/D1) becomes closer to 1.00, the particle diameter distribution becomes sharper. In the case of toner having such a small diameter and a narrow particle diameter distribution, the distribution of electrical charge can be uniform, and thus high-quality image with scattering of toner in the backgrounds reduced can be produced. Further, in electrostatic transfer methods, the transfer ratio can be improved.

The particle diameter distribution of toner can be measured by a Coulter counter TA-II or Coulter Multisizer II from Beckman Coulter, Inc in the following method, for example.

Initially, 0.1 ml to 5 ml of surfactant, preferably alkylbenzene sulfonate, is added as dispersant to 100 ml to 150 ml of electrolyte. Usable electrolytes include ISOTON-II from Coulter Scientific Japan, Ltd., which is a NaCl aqueous solution including a primary sodium chloride of 1%. Then, 2 mg to 20 mg of the sample (toner) is added to the electrolyte solution. The sample suspended in the electrolyte solution is dispersed by an ultrasonic disperser for about 1 to 3 min to prepare sample dispersion liquid. Weight and number of toner particles for each of the following channels are measured by the above-mentioned measurer using an aperture of 100 μm to determine a weight distribution and a number distribution. The weight average particle size (D4) and the number average particle diameter (D1) can be obtained from the distribution thus determined.

The number of channels used in the measurement is thirteen. The ranges of the channels are from 2.00 μm to less than 2.52 μm, from 2.52 μm to less than 3.17 μm, from 3.17 μm to less than 4.00 μm, from 4.00 μm to less than 5.04 μm, from 5.04 μm to less than 6.35 μm, from 6.35 μm to less than 8.00 μm, from 8.00 μm to less than 10.08 μm, from 10.08 μm to less than 12.70 μm, from 12.70 μm to less than 16.00 μm, from 16.00 μm to less than 20.20 μm, from 20.20 μm to less than 25.40 μm, from 25.40 μm to less than 32.00 μm, from 32.00 μm to less than 40.30 μm. The range to be measured is set from 2.00 μm to less than 40.30 μm.

The toner preferably used in the present embodiment is obtained by cross-linking reaction and/or elongation reaction of a toner constituent liquid in an aqueous solvent. Here, the toner constituent liquid is prepared by dispersing polyester prepolymer including a functional group having at least a nitrogen atom, polyester, colorant, and a releasing agent in an organic solvent. Such toner is called polymerized toner.

A description is now given of toner constituents and a method for manufacturing toner.

(Polyester)

The polyester is prepared by polycondensation reaction between a polyalcohol compound and a polycarboxylic acid compound. Specific examples of polyalcohol compound (PO) include diol (DIO) and polyalcohol having 3 or more valances (TO). The DIO alone, or a mixture of the DIO and a smaller amount of the TO are preferably used as the PO. Specific examples of diol (DIO) include alkylene glycols (e.g., ethylene glycol, 1,2-propylene glycol, 1,3-propylene glycol, 1,4-butanediol, and 1,6-hexanediol), alkylene ether glycols (e.g., diethylene glycol, triethylene glycol, dipropyrene glycol, polyethylene glycol, polypropylene glycol, and polytetramethylene ether glycol), alicyclic diols (e.g., 1,4-cyclohexane dimethanol, and hydrogenated bisphenol A), bisphenol (e.g., bisphenol A, bisphenol F, and bisphenol S), alkylene oxide adducts of the above-described alicyclic diols (e.g., ethylene oxide, propylene oxide, and butylene oxide), and alkylene oxide adducts of the above-described bisphenol (e.g., ethylene oxide, propylene oxide, and butylene oxide). Among the above-described examples, alkylene glycols having 2 to 12 carbon atoms and alkylene oxide adducts of bisphenol are preferably used. More preferably, alkylene glycol having 2 to 12 carbon atoms and alkylene oxide adducts of bisphenol are used together. Specific examples of polyalcohol having 3 or more valances (TO) include aliphatic polyalcohol having 3 to 8 or more valances (e.g., glycerin, trimethylolethane, trimethylol propane, pentaerythritol, and sorbitol), phenols having 3 or more valances (e.g., trisphenol PA, phenol novolac, and cresol novolac), and alkylene oxide adducts of polyphenols having 3 or more valances.

Specific examples of polycarboxylic acids (PC) include dicarboxylic acids (DIC) and polycarboxylic acids having 3 or more valances (TC). The DIC alone, and a mixture of DIC and a smaller amount of TC are preferably used as PC. Specific examples of dicarboxylic acids (DIC) include alkylene dicarboxylic acids (e.g., succinic acid, adipic acid, and sebacic acid), alkenylene dicarboxylic acids (e.g., maleic acid and fumaric acid), and aromatic dicarboxylic acids (e.g., phthalic acid, isophthalic acid, terephthalic acid, and naphthalene dicarboxylic acid). Among the above-described examples, alkenylene dicarboxylic acids having 4 to 20 carbon atoms and aromatic dicarboxylic acids having 8 to 20 carbon atoms are preferably used. Specific examples of polycarboxylic acids having 3 or more valances (TC) include aromatic polycarboxylic acids having 9 to 20 carbon atoms (e.g., trimellitic acid and pyromellitic acid). The polycarboxylic acid (PC) may be reacted with polyol (PO) using acid anhydrides or lower alkyl esters (e.g., methyl ester, ethyl ester, and isopropyl ester) of the above-described materials.

A ratio of polyol (PO) and polycarboxylic acid (PC) is normally set in a range between 2/1 and 1/1, preferably between 1.5/1 and 1/1, and more preferably between 1.3/1 and 1.02/1 as an equivalent ratio [OH]/[COOH] between a hydroxyl group [OH] and a carboxyl group [COOH].

The polycondensation reaction between the polyol (PO) and the polycarboxylic acid (PC) is carried out by heating the PO and the PC to from 150° C. to 280° C. in the presence of a known catalyst for esterification such as tetrabutoxy titanate and dibutyltin oxide and removing produced water under a reduced pressure as necessary to obtain a polyester having hydroxyl groups. The polyester preferably has a hydroxyl value not less than 5, and an acid value of from 1 to 30, and preferably from 5 to 20. When the polyester has the acid value within the range, the resultant toner tends to be negatively charged to have good affinity with a recording paper, and low-temperature fixability of the toner on the recording paper improves. However, when the acid value is too large, the resultant toner is not stably charged and the stability becomes worse by environmental variations.

The polyester preferably has a weight-average molecular weight of from 10,000 to 400,000, and more preferably from 20,000 to 200,000. When the weight-average molecular weight is too small, offset resistance of the resultant toner deteriorates. By contrast, when the weight-average molecular weight is too large, low-temperature fixability thereof deteriorates.

The polyester preferably includes urea-modified polyester as well as unmodified polyester obtained by the above-described polycondensation reaction. The urea-modified polyester is prepared by reacting a polyisocyanate compound (PIC) with a carboxyl group or a hydroxyl group at the end of the polyester obtained by the above-described polycondensation reaction to form a polyester prepolymer (A) having an isocyanate group, and reacting amine with the polyester prepolymer (A) to crosslink and/or elongate a molecular chain thereof.

Specific examples of polyisocyanate compound (PIC) include aliphatic polyisocyanates (e.g., tetramethylene diisocyanate, hexamethylene diisocyanate, and 2,6-diisocyanate methylcaproate), alicyclic polyisocyanates (e.g., isophorone diisocyanate and cyclohexyl methane diisocyanate), aromatic diisocyanates (e.g., trilene diisocyanate and diphenylmethane diisocyanate), aromatic aliphatic diisocyanates (e.g., α,α,α″,α″-tetramethyl xylylene diisocyanate), isocyanurate, materials blocked against the polyisocyanate with phenol derivatives, oxime, caprolactam or the like, and combinations of two or more of the above-described materials.

The PIC is mixed with the polyester such that an equivalent ratio [NCO]/[OH] between an isocyanate group [NCO] in the PIC and a hydroxyl group [OH] in the polyester is typically in a range between 5/1 and 1/1, preferably between 4/1 and 1.2/1, and more preferably between 2.5/1 and 1.5/1. When [NCO]/[OH] is too large, for example, greater than 5, low-temperature fixability of the resultant toner deteriorates. When [NCO]/[OH] is too small, for example, less than 1, a urea content in ester of the modified polyester decreases and hot offset resistance of the resultant toner deteriorates.

The polyester prepolymer (A) typically includes a polyisocyanate group of from 0.5 to 40% by weight, preferably from 1 to 30% by weight, and more preferably from 2 to 20% by weight. When the content is too small, for example, less than 0.5% by weight, hot offset resistance of the resultant toner deteriorates, and in addition, the heat resistance and low-temperature fixability of the toner also deteriorate. By contrast, when the content is too large, low-temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is too small per 1 molecule, the molecular weight of the urea-modified polyester decreases and hot offset resistance of the resultant toner deteriorates.

Specific examples of amines (B) reacted with the polyester prepolymer (A) include diamines (B1), polyamines (B2) having 3 or more amino groups, amino alcohols (B3), amino mercaptans (B4), amino acids (B5), and blocked amines (B6) in which the amines (B1 to B5) described above are blocked.

Specific examples of diamines (B1) include aromatic diamines (e.g., phenylene diamine, diethyltoluene diamine, and 4,4″-diaminodiphenyl methane), alicyclic diamines (e.g., 4,4″-diamino-3,3″-dimethyldicyclohexylmethane, diamine cyclohexane, and isophorone diamine), and aliphatic diamines (e.g., ethylene diamine, tetramethylene diamine, and hexamethylene diamine).

Specific examples of polyamines (B2) having three or more amino groups include diethylene triamine and triethylene tetramine. Specific examples of the amino alcohols (B3) include ethanol amine and hydroxyethyl aniline. Specific examples of amino mercaptan (B4) include aminoethyl mercaptan and aminopropyl mercaptan.

Specific examples of amino acids (B5) include amino propionic acid and amino caproic acid. Specific examples of the blocked amines (B6) include ketimine compounds prepared by reacting one of the amines B1 to B5 described above with a ketone such as acetone, methyl ethyl ketone and methyl isobutyl ketone; and oxazoline compounds. Among the above-described amines (B), diamines (B1) and a mixture of the B1 and a smaller amount of B2 are preferably used.

A mixing ratio [NCO]/[NHx] of the content of isocyanate groups in the prepolymer (A) to that of amino groups in the amine (B) is typically from 1/2 to 2/1, preferably from 1.5/1 to 1/1.5, and more preferably from 1.2/1 to 1/1.2.

When the mixing ratio is too large or small, molecular weight of the urea-modified polyester decreases, resulting in deterioration of hot offset resistance of the toner. The urea-modified polyester may include a urethane bonding as well as a urea bonding. The molar ratio (urea/urethane) of the urea bonding to the urethane bonding is typically from 100/0 to 10/90, preferably from 80/20 to 20/80, and more preferably from 60/40 to 30/70. When the content of the urea bonding is too small, for example, less than 10%, hot offset resistance of the resultant toner deteriorates.

The urea-modified polyester is prepared by a method such as a one-shot method. The PO and the PC are heated to from 150° C. to 280° C. in the presence of a known esterification catalyst such as tetrabutoxy titanate and dibutyltin oxide, and removing produced water while optionally depressurizing to prepare polyester having a hydroxyl group. Next, the polyisocyanate (PIC) is reacted with the polyester at from 40° C. to 140° C. to form a polyester prepolymer (A) having an isocyanate group. Further, the amines (B) are reacted with the polyester prepolymer (A) at from 0° C. to 140° C. to form a urea-modified polyester.

When the polyisocyanate (PIC), and the polyester prepolymer (A) and the amines (B) are reacted, a solvent may optionally be used. Suitable solvents include solvents which do not react with polyvalent polyisocyanate compound (PIC). Specific examples of such solvents include aromatic solvents such as toluene and xylene; ketones such as acetone, methyl ethyl ketone and methyl isobutyl ketone; esters such as ethyl acetate; amides such as dimethylformamide and dimethylacetoaminde; ethers such as tetrahydrofuran.

A reaction terminator may optionally be used in the cross-linking and/or the elongation reaction between the polyester prepolymer (A) and the amines (B) to control the molecular weight of the resultant urea-modified polyester. Specific examples of the reaction terminators include monoamines (e.g., diethylamine, dibutylamine, butylamine and laurylamine), and their blocked compounds (e.g., ketimine compounds).

The weight-average molecular weight of the urea-modified polyester is not less than 10,000, preferably from 20,000 to 10,000,000, and more preferably from 30,000 to 1,000,000. When the weight-average molecular weight is too small, hot offset resistance of the resultant toner deteriorates. The number-average molecular weight of the urea-modified polyester is not particularly limited when the above-described unmodified polyester resin is used in combination. Specifically, the weight-average molecular weight of the urea-modified polyester resins has priority over the number-average molecular weight thereof. However, when the urea-modified polyester is used alone, the number-average molecular weight is from 2,000 to 15,000, preferably from 2,000 to 10,000, and more preferably from 2,000 to 8,000. When the number-average molecular weight is too large, low temperature fixability of the resultant toner and glossiness of full-color images deteriorate.

A combination of the urea-modified polyester and the unmodified polyester improves low temperature fixability of the resultant toner and glossiness of full-color images produced thereby, and is more preferably used than using the urea-modified polyester alone. It is to be noted that unmodified polyester may contain a polyester modified using chemical bond except urea bond.

It is preferable that the urea-modified polyester mixes, at least partially, with the unmodified polyester to improve the low temperature fixability and hot offset resistance of the resultant toner. Therefore, the urea-modified polyester preferably has a composition similar to that of the unmodified polyester.

A mixing ratio between the unmodified polyester and the urea-modified polyester is from 20/80 to 95/5, preferably from 70/30 to 95/5, more preferably from 75/25 to 95/5, and even more preferably from 80/20 to 93/7. When the content of the urea-modified polyester is too small, the hot offset resistance deteriorates, and in addition, it is disadvantageous to have both high temperature preservability and low temperature fixability.

The binder resin including the unmodified polyester and urea-modified polyester preferably has a glass transition temperature (Tg) of from 45° C. to 65° C., and preferably from 45° C. to 60° C. When the glass transition temperature is too low, for example, lower than 45° C., the high temperature preservability of the toner deteriorates. By contrast, when the glass transition temperature is too high, for example, higher than 65° C., the low temperature fixability deteriorates.

Because the urea-modified polyester is likely to be present on a surface of the parent toner, the resultant toner has better heat resistance preservability than known polyester toners even though the glass transition temperature of the urea-modified polyester is low.

(Colorant)

Specific examples of colorants for the toner usable in the present embodiment include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN, and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G; Brilliant Fast Scarlet, Brilliant Carmine BS, PERMANENT RED (F2R, F4R, FRL, FRLL, and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. These materials can be used alone or in combination. The toner preferably includes a colorant in an amount of from 1 to 15% by weight, and more preferably from 3 to 10% by weight.

The colorant for use in the present invention can be combined with resin and used as a master batch. Specific examples of resin for use in the master batch include, but are not limited to, styrene polymers and substituted styrene polymers (e.g., polystyrenes, poly-p-chlorostyrenes, and polyvinyltoluenes), copolymers of vinyl compounds and the above-described styrene polymers or substituted styrene polymers, polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylic acids, rosins, modified rosins, terpene resins, aliphatic or alicyclic hydrocarbon resins, aromatic petroleum resins, chlorinated paraffins, paraffin waxes, etc. These resins can be used alone or in combination.

(Charge Controlling Agent)

The toner usable in the present embodiment may optionally include a charge controlling agent. Specific examples of the charge controlling agent include any known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and salicylic acid derivatives, but are not limited thereto. Specific examples of commercially available charge controlling agents include, but are not limited to, BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGES NX VP434 (quaternary ammonium salt), which are manufactured by Hoechst A G; LR1-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. Among the above-described examples, materials that adjust toner to have the negative polarity are preferable.

The content of the charge controlling agent is determined depending on the species of the binder resin used, and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large a charge quantity. Accordingly, the electrostatic attraction of the developing roller 42 attracting toner increases, thus degrading fluidity of toner and image density.

(Release Agent)

When wax having a low melting point of from 50° C. to 120° C. is used in toner as a release agent, the wax can be dispersed in the binder resin and serve as a release agent at an interface between the fixing roller of the fixing device 12 and toner particles. Accordingly, hot offset resistance can be improved without applying a release agent, such as oil, to the fixing roller. Specific examples of the release agent include natural waxes including vegetable waxes such as carnauba wax, cotton wax, Japan wax and rice wax; animal waxes such as bees wax and lanolin; mineral waxes such as ozokelite and ceresine; and petroleum waxes such as paraffin waxes, microcrystalline waxes, and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes, and ether waxes. Further, fatty acid amides such as 1,2-hydroxylstearic acid amide, stearic acid amide, and phthalic anhydride imide; and low molecular weight crystalline polymers such as acrylic homopolymer and copolymers having a long alkyl group in their side chain such as poly-n-stearyl methacrylate, poly-n-laurylmethacrylate, and n-stearyl acrylate-ethyl methacrylate copolymers can also be used.

The above-described charge control agents and release agents can be fused and kneaded together with the master batch pigment and the binder resin. Alternatively, these can be added thereto when the ingredients are dissolved or dispersed in an organic solvent.

(External Additives)

An external additive is preferably added to toner particles to improve the fluidity, developing property, and charging ability. Preferable external additives include inorganic particles. The inorganic particles preferably have a primary particle diameter of from 5×10⁻³ μm to 2 μm, and more preferably, from 5×10⁻³ μm to 0.5 μm. In addition, the inorganic particles preferably has a specific surface area measured by a BET method of from 20 to 500 m²/g. The content of the external additive is preferably from 0.01 to 5% by weight, and more preferably, from 0.01 to 2.0% by weight, based on total weight of the toner composition.

Specific examples of inorganic particles include particles of silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Among the above-described examples, a combination of a hydrophobic silica and a hydrophobic titanium oxide is preferably used. In particular, the hydrophobic silica and the hydrophobic titanium oxide each having an average particle diameter of not greater than 5×10⁻² μm considerably improves an electrostatic force between the toner particles and van der Waals force. Accordingly, the resultant toner composition has a proper charge quantity. In addition, even when toner is agitated in the development device to attain a desired charge amount, the external additive is hardly released from the toner particles. As a result, image failure such as white spots and image omissions rarely occur. Further, the amount of residual toner after image transfer can be reduced.

When fine titanium oxide particles are used as the external additive, the resultant toner can reliably form toner images having a proper image density even when environmental conditions are changed. However, the charge rising properties of the resultant toner tend to deteriorate. Therefore, the amount of fine titanium oxide particles added is preferably smaller than that of silica fine particles.

The amount in total of fine particles of hydrophobic silica and hydrophobic titanium oxide added is preferably from 0.3 to 1.5% by weight based on weight of the toner particles to reliably form high-quality images without degrading charge rising properties even when images are repeatedly copied.

A method for manufacturing the toner is described in detail below, but is not limited thereto.

(Toner Manufacturing Method)

(1) The colorant, the unmodified polyester, the polyester prepolymer having an isocyanate group, and the release agent are dispersed in an organic solvent to obtain toner constituent liquid. Volatile organic solvents having a boiling point lower than 100° C. are preferable because such organic solvents can be removed easily after formation of parent toner particles. Specific examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethylketone, and methylisobutylketone. The above-described materials can be used alone or in combination. In particular, aromatic solvent such as toluene and xylene, and chlorinated hydrocarbon such as methylene chloride, 1,2-dichloroethane, chloroform, and carbon tetrachloride are preferably used. The toner constituent liquid preferably includes the organic solvent in an amount of from 0 to 300 parts by weight, more preferably from 0 to 100 parts by weight, and even more preferably from 25 to 70 parts by weight based on 100 parts by weight of the prepolymer.

(2) The toner constituent liquid is emulsified in an aqueous medium under the presence of a surfactant and a particulate resin. The aqueous medium may include water alone or a mixture of water and an organic solvent. Specific examples of the organic solvent include alcohols such as methanol, isopropanol, and ethylene glycol; dimethylformamide; tetrahydrofuran; cellosolves such as methyl cellosolve; and lower ketones such as acetone and methyl ethyl ketone.

The toner constituent liquid includes the aqueous medium in an amount of from 50 to 2,000 parts by weight, and preferably from 100 to 1,000 parts by weight based on 100 parts by weight of the toner constituent liquid. When the amount of the aqueous medium is too small, the toner constituent liquid is not well dispersed and toner particles having a predetermined particle diameter cannot be formed. By contrast, when the amount of the aqueous medium is too large, production costs increase.

A dispersant such as a surfactant or an organic particulate resin is optionally included in the aqueous medium to improve the dispersion therein. Specific examples of the surfactants include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives, and imidazoline) and quaternary ammonium salts (e.g., alkyltrimethyl ammonium salts, dialkyldimethyl ammonium salts, alkyldimethyl benzyl ammonium salts, pyridinium salts, alkyl isoquinolinium salts, and benzethonium chloride); nonionic surfactants such as fatty acid amide derivatives and polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can achieve a dispersion having high dispersibility even when a smaller amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-[ω-fluoroalkyl(C6-C11)oxy]-1-alkyl(C3-C4) sulfonate, sodium-[ω-fluoroalkanoyl(C6-C8)-N-ethylamino]-1-propane sulfonate, fluoroalkyl(C11-C20) carboxylic acids and their metal salts, perfluoroalkylcarboxylic acids (C7-C13) and their metal salts, perfluoroalkyl(C4-C12) sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonylglycin, and monoperfluoroalkyl(C6-C16)ethylphosphates.

Specific examples of commercially available surfactants include SURFLON® S-111, SURFLON® S-112, and SURFLON® S-113 manufactured by AGC Seimi Chemical Co., Ltd.; FRORARD FC-93, FC-95, FC-98, and FC-129 manufactured by Sumitomo 3M Ltd.; UNIDYNE DS-101 and DS-102 manufactured by Daikin Industries, Ltd.; MEGAFACE F-110, F-120, F-113, F-191, F-812, and F-833 manufactured by DIC Corporation; EFTOP EF-102, EF-103, EF-104, EF-105, EF-112, EF-123A, EF-123B, EF-306A, EF-501, EF-201, and EF-204 manufactured by JEMCO Inc.; and FUTARGENT F-100 and F-150 manufactured by Neos Co., Ltd.

Specific examples of cationic surfactants include primary and secondary aliphatic amines or secondary amino acid having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, and imidazolinium salts. Specific examples of commercially available products thereof include SURFLON® S-121 manufactured by AGC Seimi Chemical Co., Ltd.; FRORARD FC-135 manufactured by Sumitomo 3M Ltd.; UNIDYNE DS-202 manufactured by Daikin Industries, Ltd.; MEGAFACE F-150 and F-824 manufactured by DIC Corporation; EFTOP EF-132 manufactured by JEMCO Inc.; and FUTARGENT F-300 manufactured by Neos Co., Ltd.

The resin particles are added to stabilize parent toner particles formed in the aqueous medium. Therefore, the resin particles are preferably added so as to have a coverage of from 10% to 90% over a surface of the parent toner particles. Specific examples of the resin particles include polymethylmethacrylate particles having a particle diameter of 1 μm and 3 μm, polystyrene particles having a particle diameter of 0.5 μm and 2 μm, and poly(styrene-acrylonitrile) particles having a particle diameter of 1 μm. Specific examples of commercially available products thereof include PB-200H manufactured by Kao Corporation, SGP manufactured by Soken Chemical & Engineering Co., Ltd., Technopolymer SB manufactured by Sekisui Plastics Co., Ltd., SGP-3G manufactured by Soken Chemical & Engineering Co., Ltd., and Micropearl manufactured by Sekisui Chemical Co., Ltd.

In addition, inorganic dispersants such as tricalcium phosphate, calcium carbonate, titanium oxide, colloidal silica, and hydroxy apatite can also be used.

To stably disperse toner constituents in water, a polymeric protection colloid may be used in combination with the above-described resin particles and an inorganic dispersant. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid, and maleic anhydride), (meth)acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, glycerinmonomethacrylic acid esters, N-methylolacrylamide, and N-methylolmethacrylamide), vinyl alcohol and its ethers (e.g., vinyl methyl ether, vinyl ethyl ether, and vinyl propyl ether), esters of vinyl alcohol with a compound having a carboxyl group (e.g., vinyl acetate, vinyl propionate, and vinyl butyrate), acrylic amides (e.g., acrylamide, methacrylamide, and diacetoneacrylamide) and their methylol compounds, acid chlorides (e.g., acrylic acid chloride and methacrylic acid chloride), nitrogen-containing compounds (e.g., vinyl pyridine, vinyl pyrrolidone, vinyl imidazole, and ethylene imine), and homopolymer or copolymer having heterocycles of the nigtroge-containing compounds. In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds (e.g., methyl cellulose, hydroxyethyl cellulose, and hydroxypropyl cellulose) can also be used as the polymeric protective colloid.

The dispersion method is not particularly limited, and well-known methods such as low speed shearing methods, high-speed shearing methods, friction methods, high-pressure jet methods, and ultrasonic methods can be used. Among the above-described methods, the high-speed shearing methods are preferably used because particles having a particle diameter of from 2 to 20 μm can be easily prepared. When a high-speed shearing type dispersion machine is used, the rotation speed is not particularly limited, but the rotation speed is typically from 1,000 to 30,000 rpm, and preferably from 5,000 to 20,000 rpm. The dispersion time is not particularly limited, but is typically from 0.1 to 5 minutes for a batch method. The temperature in the dispersion process is typically from 0° C. to 150° C. (under pressure), and preferably from 40° C. to 98° C.

(3) While the emulsion is prepared, amines (B) are added thereto to react with the polyester prepolymer (A) having an isocyanate group. This reaction is accompanied by cross-linking and/or elongation of a molecular chain. The reaction time depends on reactivity of an isocyanate structure of the polyester prepolymer (A) and amines (B), but is typically from 10 minutes to 40 hours, and preferably from 2 to 24 hours. The reaction temperature is typically from 0° C. to 150° C., and preferably from 40° C. to 98° C. In addition, a known catalyst such as dibutyltinlaurate and dioctyltinlaurate can be used as needed.

(4) After completion of the reaction, the organic solvent is removed from the emulsified dispersion (a reactant), and subsequently, the resulting material is washed and dried to obtain a parent toner particle. The prepared emulsified dispersion is gradually heated while stirred in a laminar flow, and an organic solvent is removed from the dispersion after stirred strongly when the dispersion has a specific temperature to form a parent toner particle having the shape of a spindle. When an acid such as calcium phosphate or a material soluble in alkaline is used as a dispersant, the calcium phosphate is dissolved with an acid such as a hydrochloric acid, and washed with water to remove the calcium phosphate from the parent toner particle. Besides the above-described method, the organic solvent can also be removed by an enzymatic hydrolysis.

(5) A charge control agent is provided to the parent toner particle, and fine particles of an inorganic material such as silica or titanium oxide are added thereto to obtain toner. Well known methods using a mixer or the like are used to provide the charge control agent and to add inorganic particles. Accordingly, toner having a smaller particle diameter and a sharper particle diameter distribution can be easily obtained. Further, strong agitation in removal of the organic solvent can cause toner particles to have a shape between a spherical shape and a spindle shape, and surface morphology between a smooth surface and a rough surface.

Next, a distinctive feature of the present embodiment is described below.

FIG. 24 is an enlarged view of the contact portion between the development roller 42 and the doctor blade 45.

As shown in FIG. 24, the stress of the doctor blade 45 acts in the direction indicated by arrow Fb. Since the development roller 42 rotates in the direction B during image development, toner T held in the recesses 42b receives the compression force in the direction indicated by arrow Fa due the stress of the doctor blade 45 in the direction Fb.

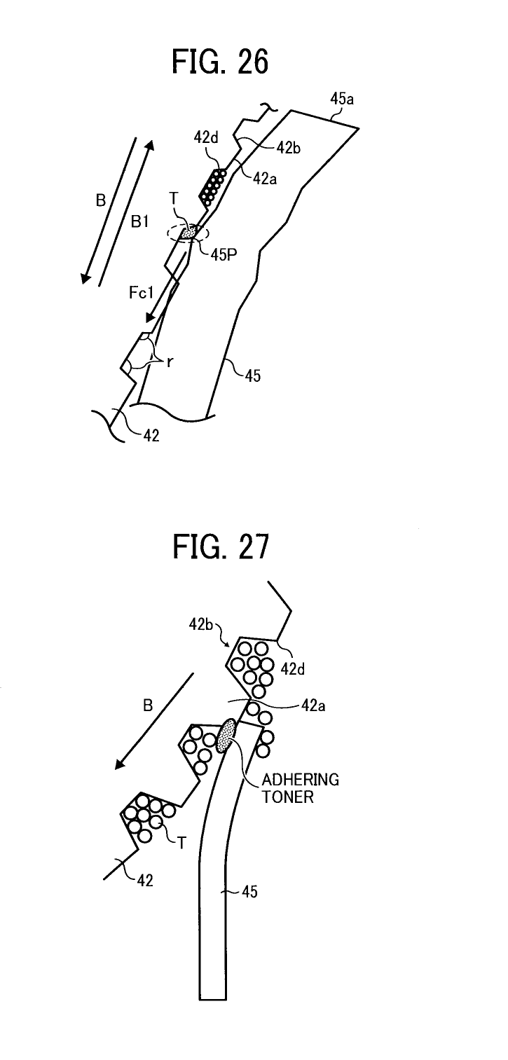

As shown in FIG. 26, the surface of the doctor blade 45 is not perfectly smooth but has projections 45P and recesses of the order of several micron meters. Therefore, when the projection 45P of the doctor blade 45 enters the recess 42b of the development roller 42, it is possible that the upstream wall of the projection 45P of the doctor blade 45 in the direction B, in which the development roller 42 rotates during image development, presses toner T against the upstream wall of the recess 42b in the direction B. Thus, the compression force exerted by the doctor blade 45 on the toner can be stronger. In such a case, toner can coagulate in the area enclosed with dotted circle (also shown in FIG. 11C) adjacent to the upstream wall of the recess 42b in the direction B.

Additionally, as shown in FIG. 27, in the present embodiment, toner is leveled off such that toner on the projections 42a is removed by the doctor blade 45, and only toner retained in the recesses 42b is transported to the development range to keep the amount of toner transported constant. In practice, however, it is difficult for the doctor blade 45 to remove toner completely from the projections 42a. Accordingly, a small amount of toner can enter the nip between the doctor blade 45 and the development roller 42 and adhere to the doctor blade 45 due to sliding contact between the doctor blade 45 and the development roller 42.

At an early stage of use, toner adhering to the doctor blade 45 can be scraped off by the corner 42d of the projection 42a on the downstream side in the direction B. The corner 42d crosses the upstream wall of the recess 42b in the direction B. Accordingly, toner can be removed before the toner is fused by heat generated by the sliding contact between the doctor blade 45 and the development roller 42 and solidifies on the doctor blade 45.

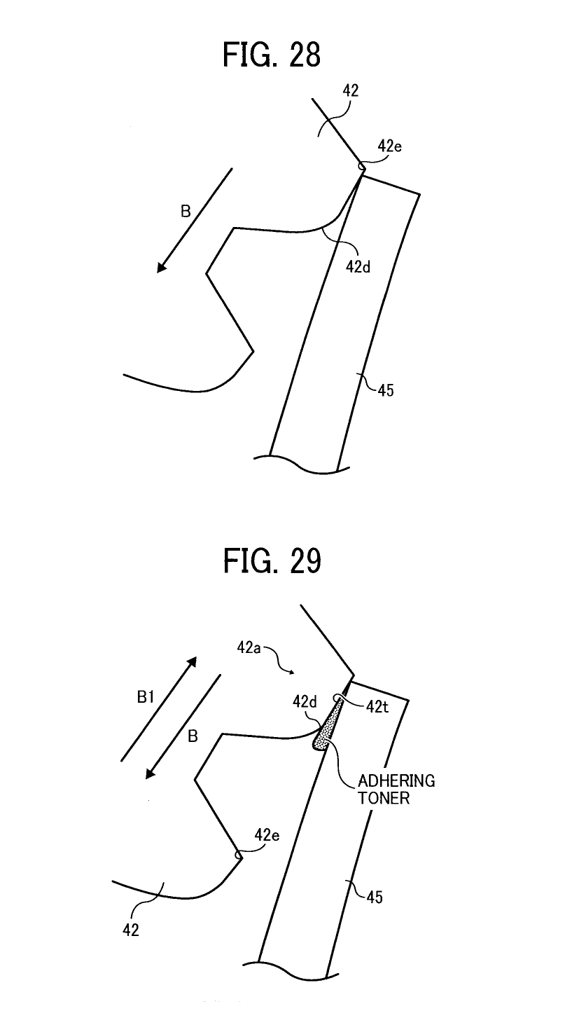

FIG. 28 is an enlarged view illustrating a state after the development device 4 has operated for a long time, in which toner adheres to the doctor blade 45. It is to be noted that reference character 42e shown in FIG. 28 represent a corner of the projection 42a on the opposite side of the corner 42d.

As shown in FIG. 28, after a long period of use, the corner 42d of the projection 42a wears, that is, the corner 42d is abraded and rounded off. When the corner 42d is rounded, the force for scraping off toner from the doctor blade 45 is reduced. Further, referring to FIG. 29, toner that is not removed by the corner 42d but remains on the doctor blade 45 is pressed against the top face 42t of the projection 42a and increases in layer thickness in the direction B in which the development roller 42 rotates during image development. That is, the toner layer on the doctor blade 45 is thicker on the downstream side than on the upstream side in the direction B. As the doctor blade 45 slidingly contacts the development roller 42, the toner on the doctor blade 45 is fused and then solidifies. The toner solidified on the doctor blade 45 grows in size over time. In such a state, the toner solidified on the doctor blade 45 can remove toner from the recess 42b, and the amount of toner transported decreases partly, resulting in substandard images in which toner is partly absent on the resultant image.

Therefore, in the present embodiment, an operation in which the development roller 42 is rotated in reverse to the direction B for image development is performed separately from image development.

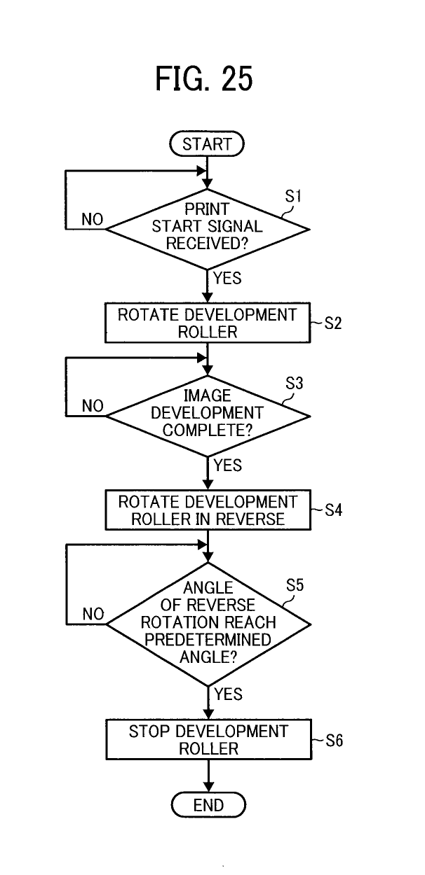

FIG. 25 is a flowchart for controlling rotation of the development roller 42.

As shown in FIG. 25, when the controller 140 (shown in FIG. 23) receives a print start signal (YES at S1), the controller 140 causes the driving unit 143 to rotate the development roller 42 in the normal direction B (shown in FIGS. 2, 5, 11B, and 24) for image development. Then, toner carried on the development roller 42 is transported to the development range to develop the latent image formed on the photoreceptor 2. When development of the latent image is completed (YES at S3), at S4 the controller 140 causes the driving unit 143 to rotate the development roller 42 in reverse.

FIG. 26 is an enlarged view of the contact portion between the development roller 42 and the doctor blade 45 while the development roller 42 is rotated in the direction indicated by arrow B1 (hereinafter “reverse direction B1”) reverse to the normal direction B for image development.

As shown in FIG. 26, when the development roller 42 is rotated in the reverse direction B1, the projection 45P of the doctor blade 45 exerts a pressing force in the direction indicated by arrow Fc1 (hereinafter “direction Fc1”) on the toner agglomerating in the area 42c adjacent to the corner 42d of the projection 42a of the development roller 42. Specifically, an upstream face of the projection 45P in the reverse direction B1 exerts the pressing force in the direction Fc1. This force can loosen the toner agglomerating in the area 42c and inhibit agglomeration of toner in the area 42c, which is adjacent to the upstream wall of the recess 42b in the normal direction B in which the development roller 42 rotates for image development. Consequently, creation of toner filming can be inhibited, and fluctuations in the charge amount Q per unit volume M (Q/M) as well as the toner amount M carried on the roller unit area A (MIA) can be reduced.

Additionally, since the angle γ between the side face of the projection 42a and the bottom face of the recess 42b is 90° or greater, the probability of contact between toner accumulating in the recess 42b and the projections 45P of the doctor blade 45 can increase. Thus, the projections 45P of the doctor blade 45 can loosen the accumulating toner sufficiently.

Additionally, when the doctor blade 45 is constructed of a material harder than the surface layer of the development roller 42, abrasion of the projections 45P of the doctor blade 45 can be alleviated. Thus, toner can be inhibited from agglomerating in the area 42c.

Additionally, the velocity at which the development roller 42 is rotated in the reverse direction B1 is slower than the velocity at which the development roller 42 is rotated in the normal direction B during image development. This operation can make it easier for the projections 45P of the doctor blade 45 to enter the recesses 42b in the surface of the development roller 42. Accordingly, toner accumulating adjacent to the area 42c (shown in FIG. 26) can be loosened and pushed out by the projections 45P of the doctor blade 45.

While the development roller 42 rotates in reverse, the controller 140 may cause the bias power source 145, serving as the electrical field generator, to generate, between the development roller 42 and the doctor blade 45, an electrical field in the direction for attracting toner from the development roller 42 to the doctor blade 45. Specifically, since alternating voltage is not applied to the development roller 42 from the development bias power source 142 during the reverse rotation of the development roller 42, the DC voltage in the polarity (positive or plus polarity) opposite the polarity of normal charge of toner (negative or minus polarity) is applied to the doctor blade 45. Such an electrical field can exerts an electrostatic force for moving toner accumulating in the area 42c toward the doctor blade 45. Thus, the toner accumulating in the area 42c can be loosened better.

The toner loosened by the doctor blade 45 is transported to the supply nip β and collected by the supply roller 44. At that time, differences in rotational velocity between the development roller 42 and the supply roller 44 can help the supply roller 44 to collect toner from the development roller 42.

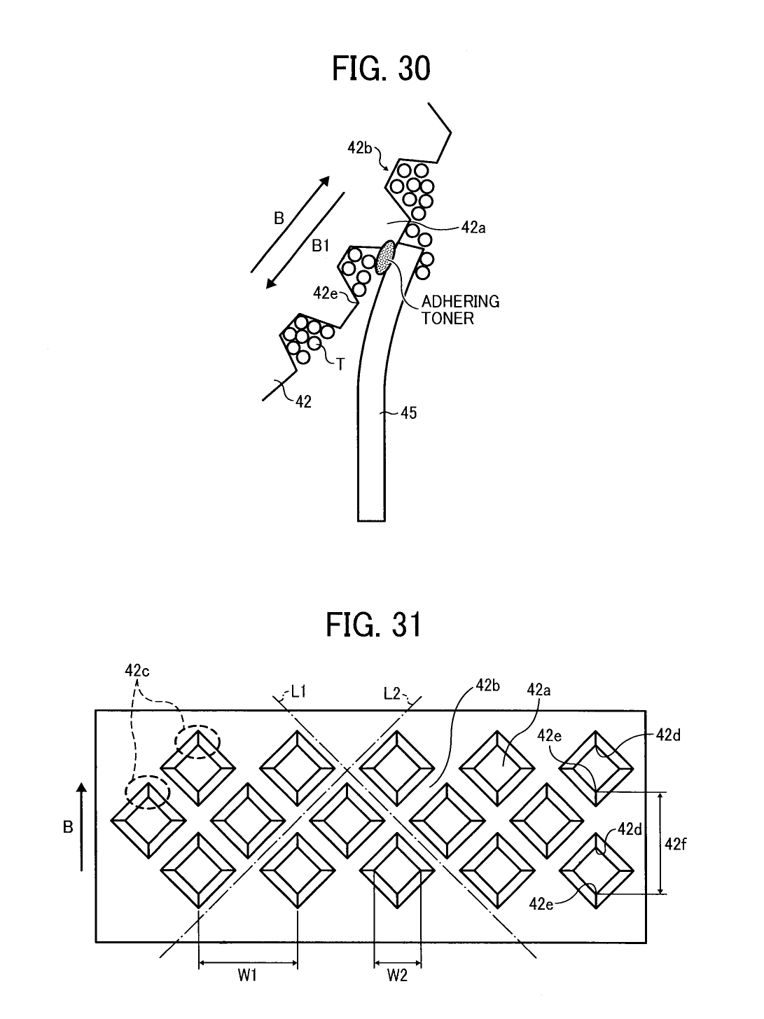

Further, referring to FIG. 30, reverse rotation of the development roller 42 can further attain the following effect. While the development roller 42 rotates in reverse, toner adhering to the doctor blade 45 can be removed by the corner 42e (on the upstream side in the normal direction B and on the downstream side in the reverse direction B1) of the projection 42a of the development roller 42. While the corner 42d on the downstream side in the normal direction B is abraded because it contacts the doctor blade 45, the opposite corner 42e is less abraded by the doctor blade 45 during image development. Thus, the corner 42e can be kept sharp for a long time. Even if the effect of the rounded corner 42d for removing toner is degraded, toner can be removed from the doctor blade 45 by the corner 42e by rotating the development roller 42 in reverse after image development is completed.

Additionally, as described with reference to FIG. 29, toner that is not removed by the corner 42d forms the toner layer, which is thicker on the downstream side in the normal direction B, on the doctor blade 45. Therefore, when the development roller 42 rotates in reverse, the corner 42e of the projection 42a can contact the thicker side of the toner layer on the doctor blade 45. Thus, toner adhering to the doctor blade 45 can be removed by the corner 42e of the projection 42a.

Referring to FIG. 31, the amount by which the development roller 42 rotates in reverse is greater than a distance 42f between the corners 42e of two projections 42a adjacent in the circumferential direction of the development roller 42. Accordingly, the corner 42e of the projection 42a at any position in the axial direction of the development roller 42 can contact toner adhering to the doctor blade 45 at least once during the reverse rotation of the development roller 42. Consequently, each time the development roller 42 is rotated in reverse, toner can be removed from the doctor blade 45 over the entire width (corresponding to the axial length of the development roller 42), and satisfactory performance of the doctor blade 45 can be maintained.

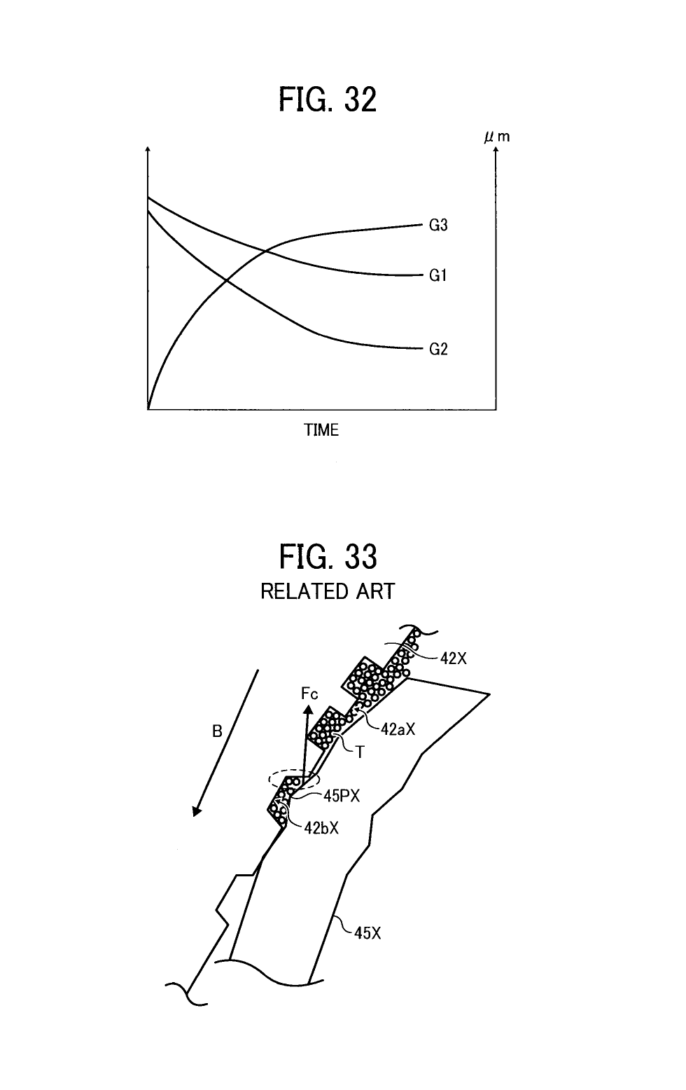

FIG. 32 is a graph illustrating the relation between the amount of wear (abrasion) of the corner 42d of the projection 42a and the capability to scrape off toner (hereinafter “toner removal capability”) from the doctor blade 45. In FIG. 32, lines G1 and G2 respectively represent toner removal capability a case in which the development roller 42 is rotated in reverse and a case in which the development roller 42 is not rotated in reverse, and line G3 that crosses the lines G1 and G2 represent the amount of wear of the corner 42d.

The corner 42d of the projection 42a can be abraded significantly during an initial period of use. The speed of abrasion slows down gradually, and then the corner 42d is abraded little. In the present embodiment, the corner 42d is abraded, for example, about 3 μm to 4 μm while the development roller 42 rotates about 60 km.

When the development roller 42 is not rotated in reverse at the end of image development, the toner removal capability for removing toner from the doctor blade 45 depends on the abrasion amount of the corner 42d and can decrease significantly during the initial period of use. When the progress of abrasion slows down until the corner 42d is abraded no more, the toner removal capability is stable at a low level.

By contrast, since the development roller 42 is rotated in reverse after completion of image development in the present embodiment, even during the initial period of use, the toner removal capability can be higher by the amount removed by the corner 42e than that in the above-described case in which the development roller 42 is not rotated in reverse. Further, even when the corner 42d is rounded off, a higher toner removal capability can be maintained because the corner 42e can remove toner from the doctor blade 45.

Referring back to the flowchart shown in FIG. 25, when the angle by which the development roller 42 rotates in reverse reach a predetermined angle (YES at S5), the development roller 42 is stopped at S6. When the angle by which the development roller 42 rotates in reverse is not greater than 360 degrees in each reverse rotation, the following inconvenience can be inhibited.

While the development roller 42 rotates in reverse, toner supplied from the supply roller 44 to the development roller 42 slips out of the entrance seal 47, passes through the development range α, and reaches the nip between the doctor blade 45 and the development roller 42. Since the free end portion of the doctor blade 45 is disposed in the direction counter to the normal direction B for image development, the free end portion is in a trailing contact with the development roller 42 during the reverse rotation. Accordingly, the capability of the doctor blade 45 to remove toner from the projections 42a (or the top faces 42t) is lower than that in the counter contact state, a part of toner on the projections 42a is not removed by the doctor blade 45 but is transported into the development device 4. However, a part of toner removed from the projections 42a by the doctor blade 45 during the reverse rotation accumulates on the opposed face 45b of the doctor blade 45 (outside the development casing 41) facing the photoreceptor 2. It is possible that the accumulating toner can fall outside the development device 4. As the rotational angle (number of rotation) in the reverse rotation of the development roller 42 increases, the amount of toner accumulating on the opposed face 45b of the doctor blade 45 increases, and a greater amount of toner can fall outside. When the rotation angle of the development roller 42 in the reverse rotation is smaller than 360 degrees, such an inconvenience can be alleviated.

By contrast, to loosen the toner accumulating in the area 42c in FIG. 11C over the entire circumference of the development roller 42, it is preferred that the development roller 42 rotate 360 degrees in reverse. To better inhibited toner aggregation, the amount by which that the development roller 42 rotates in reverse is preferably greater.

Additionally, referring to FIG. 5, when the entrance seal 47 is disposed so that only its end portion contacts the development roller 42 (end contact state) in the direction counter to the reverse direction B1, the end portion of the entrance seal 47 can level off toner from the top faces 42t of the projections 42a of the development roller 42 while the development roller 42 rotates in reverse. This configuration can reduce the amount of toner to be regulated by the doctor blade 45 while the development roller 42 rotates in reverse, thereby reducing the amount of toner falling outside the development device 4.

Regarding the contact state of the entrance seal 47, “end contact” is advantageous over “planar contact” in that the contact nip between the entrance seal 47 and the development roller 42 can be reduced, thereby reducing stress on toner. Additionally, the length of the entrance seal 47 can be reduced in the shorter side direction (perpendicular to the axial direction of the development roller 42), thus reducing costs.

Although FIG. 26 illustrates the doctor blade 45 being in planar contact with the development roller 42, when the doctor blade 45 is in end contact state, the end portion of the doctor blade 45 can enter the recess 42b and scoop out toner accumulating in the area 42c. In this case, the amount by which the end portion of the doctor blade 45 enters the recess 42b can increase by changing the contact angle between the doctor blade 45 and the development roller 42. Thus, the effect of the doctor blade 45 for scooping out toner from the area 42c can improve.

Although the development roller 42 is rotated in reverse each time image development is completed in the flowchart shown in FIG. 25, alternatively, the development roller 42 may be rotated in reverse after a predetermined number of times image development is performed. Yet alternatively, a measurement device 150 (shown in FIG. 11A) may be provided to measure the rotational distance of the development roller 42, and the development roller 42 may be rotated in reverse after the measured rotational distance exceeds a predetermined threshold. Referring to FIG. 11A, a detected member 154 such as a planar reflector or a feeler may be provided to the development roller 42 so that a detector 151 such as a photosensor can detect the detected member 154. The detector 151 shown in FIG. 11A includes a light-emitting element 152 and a light-receiving element 153. FIG. 11B illustrates, from a side, the detected member 154 provided to the development roller 42.

Thus, the detector 151 and the detected member 154 together form a measurement device 150 to measure the rotational distance. When the detector 151 detects the detected member 154, it can be deemed that the development roller 42 has made one rotation. Thus, the rotational distance thereof can be measured.

With the threshold (i.e., number of times of image development, rotational distance of the development roller 42, or the like), reverse rotation of the development roller 42 can be performed, at predetermined intervals, after accumulation of toner on the doctor blade 45 grows to the state shown in FIG. 29. This operation can streamline removal of toner from the doctor blade 45. Further, compared with a case in which reverse rotation is performed each time image development is completed, the number of times of reverse rotation can decrease, alleviating wear of the development roller 42 as well as components, such as the entrance seal 47, that slidingly contact the development roller 42. Thus, durability of the development device 4 can improve.

It is to be noted that separate components may be provided for supplying toner to the development roller 42 and collecting toner therefrom although the supply roller 44 performs both in the present embodiment. Toner can be fully collected from the development roller 42 also in that case when such a separate collecting member for collecting toner is designed to have a sponge surface layer and bite into the surface of the development roller 42 an amount greater than the height of the projection 42a. Additionally, the separate collecting member may rotate in a velocity different from that of the development roller 42. Further, a bias voltage may be applied to the collecting member to generate an electrical field between the collecting member and the development roller 42 for attracting toner from the development roller 42 to the collecting member, thereby enhancing initialization of toner.

The various configurations according to the present inventions can attain specific effects as follows.

Configuration 1: A development device includes a developer bearer, such as a development roller 42, to carry by rotation magnetic one-component developer to a development range facing a latent image bearer, such as the photoreceptor 2, and to supply the developer to a latent image formed on the latent image bearer, and a developer regulator, such as the doctor blade 45, that contacts a surface of the developer bearer to adjust an amount of developer carried to the development range α. While image development is not performed, a controller such as the controller 140 causes the developer bearer to rotate in the reverse direction to the direction of rotation thereof for image development.

This configuration can inhibit coagulation of developer in the area 42c adjacent to the upstream wall of the recess 42b in the direction of rotation for image development. Additionally, as described above, this configuration can remove developer from the developer regulator such as the doctor blade 45, thereby inhibiting firm adhesion of toner to the developer regulator.

Configuration 2: In configuration 1, the controller causes the developer bearer to rotate in the reverse direction after image development is completed. With this operation, even if developer accommodates in the area 42c during image development, such accumulation can be loosened.

Configuration 3: In configuration 1, further a distance measuring unit to measure a rotational distance of the developer bearer is provided. The distance measuring unit can include a detected member such as a feeler or a reflector; and a detector such as an optical sensor to detect the detected member. The controller causes the developer bearer to rotate in the reverse direction when the measured rotational distance of the developer bearer reaches a threshold and image development is not performed.

This configuration can alleviate wear of the surface of the developer bearer and wear of the members such as the entrance seal 47 that contacts the developer bearer compared with a case in which the developer bearer is rotated in reverse each time image development is completed, thus enhancing durability of the development device. Additionally, developer adhering to the developer regulator in the state shown in FIG. 30 can be removed efficiently.

Configuration 4: In any of configurations 1 to 3, the controller causes the developer bearer to rotate in the reverse direction a distance greater than the distance between downstream corners of two projections formed in the surface of the developer bearer, the two projections adjacent to each other in the reverse direction.

With this configuration, the corner 42e (on the downstream side in the reverse direction B1) of the projection 42a at any position in the axial direction (width direction of the developer regulator) of the development roller 42 can contact toner adhering to the doctor blade 45 at least once during the reverse rotation of the developer bearer. Accordingly, developer can be removed from the developer regulator over the entire width of the developer regulator.

Configuration 5: In any of configurations 1 to 4, the developer regulator is disposed such that an end (free end side) thereof contacts the developer bearer.

With this configuration, developer on the top face 42t of the projection 42a of the developer bearer can be removed by the end of the developer regulator. This configuration can stabilize the amount M of developer carried on the roller unit area A (M/A) that has passed by the developer bearer. Additionally, since the end of the developer bearer can enter the recess 42b, developer accumulating in the area 42c can be removed by the end portion while the developer bearer rotates in the reverse direction. Thus, accumulating developer can be loosened, inhibiting coagulation of developer in that area.

Configuration 6: In configuration 5, a corner or edge (on the free end or second end side) formed by the end face 45a and the opposed face 45b of the developer regulator contacts the developer bearer. This configuration can attain the effects described in configuration 5.

Configuration 7: In configuration 5 or 6, the second end of the developer regulator is disposed to contact the developer bearer in a direction counter to the direction of rotation of the developer bearer for image development. With this configuration, developer on the top face 42t of the projection 42a of the developer bearer can be removed by the end of the developer regulator, thus stabilizing the amount M of developer carried on the unit area A downstream from the developer regulator.

Configuration 8: In any of configurations 1 to 7, the developer regulator is constructed of a material harder than a surface layer of the developer bearer.

This configuration can inhibit abrasion of the developer regulator caused by sliding contact with the developer bearer. With this configuration, the developer regulator can sufficiently scrape off toner from the projections 42a for long time, keeping the amount of toner that has passed by the developer regulator 45 (M/A) at a desired amount. Additionally, abrasion of the projections 45P of the developer regulator can be alleviated. Thus, developer accumulating in the area 42c can be removed.

Configuration 9: In any of configurations 1 to 8, the developer regulator is constructed of a conductive material. With this configuration, charge amount of toner T having a greater charge amount Q per unit volume M (Q/M) can be reduced, and the charge amount Q of toner T per unit volume M can become uniform. Accordingly, toner T can be prevented from firmly sticking to the development roller 42.

Configuration 10: In any of configurations 1 to 9, an electrical field generator, such as the bias power source 145, is provided to generate an electrical field between the developer bearer and the developer regulator. The controller causes the electrical field generator to generate an electrical field for attracting developer to the developer regulator when the developer bearer rotates in the reverse direction.

This configuration can inhibit coagulation of developer in the area 42c adjacent to the upstream wall of the recess 42b in the direction of rotation for image development. With this operation, even if developer accommodates in the area 42c during image development, such accumulation can be loosened.

Configuration 11: in any of configurations 1 to 10, the controller causes the developer bearer to rotate in the reverse direction at a velocity slower than a velocity at which the developer bearer is rotated in the direction of rotation for image development.

This operation can increase the probability that the edge or the projection 45P of the developer regulator contacts toner accumulating in the area 42c adjacent to the upstream wall of the recess 42b in the direction of rotation for image development. Thus, developer accumulating in the area 42c can be loosened.

Configuration 12: Any of configurations 1 to 11 further includes a developer collecting member, such as the supply roller 44, that contacts the developer bearer to collect developer from a portion of the developer bearer that has passed through the development range. The developer collecting member includes a porous body having a sponge surface layer in which multiple minute pores are diffused.

This configuration can make it easier for the developer collecting member to reach the bottom of the recess 42b, thus facilitating removal of toner accumulating inside the recess 42b by the developer collecting member. Since toner can be prevented from being carried over on the developer bearer, firm adhesion of toner thereto can be inhibited. Consequently, image density unevenness resulting from toner adhesion can be reduced.

Configuration 13: Any of configurations 1 to 12 further includes the developer collecting member and an electrical field generator, such as the bias power source 144, to generate an electrical field between the developer bearer and the developer collecting member for moving developer from the developer bearer to the developer collecting member.

This configuration can facilitate removal of developer by the developer collecting member. Since toner can be prevented from being carried over by the developer bearer, firm adhesion of toner thereto can be inhibited. Consequently, image density unevenness resulting from toner adhesion can be reduced.

Configuration 14: In configuration 12 or 13, the developer bearer and the developer collecting member rotate in opposite directions in a range where the developer collecting member contacts the developer bearer. The developer collecting member is configured to supply developer from the developer container to the developer bearer and collect developer therefrom while rotating.

This configuration can reduce the number of components, thereby reducing costs, compared with a configuration in which a developer supply member is provided separately from the developer collecting member.

Configuration 15: Any of configurations 1 to 14 further includes a casing, such as the development casing 41, and a seal member, such as the entrance seal 47, to prevent leakage of developer from an opening 56 formed in the casing, on a side facing the latent image bearer. The developer bearer is housed in the casing such that the developer bearer is partly exposed through the opening 56. The seal member includes a first end attached to the casing and a second end disposed to contact the developer bearer.

This configuration can reduce the width of the contact nip between the developer bearer and the seal member, thereby alleviating stress on developer, compared with a comparative configuration in which a portion of the seal member shifted to the first end from the second end contacts the developer bearer. Additionally, compared with the comparative configuration, the short side length of the seal member can be reduced, thereby reducing the cost. Further, when the second end of the seal member is disposed to contact the developer bearer in the direction counter to the reverse rotation of the developer bearer, the second end of the seal member can scrape off developer from the top face 42t of the projection 42a of the developer bearer during reverse rotation of the developer bearer. This configuration can reduce the amount of developer regulated by the developer regulator during reverse rotation of the developer bearer, thereby reducing the amount of developer leaking outside the development device 4.

Configuration 16: The developer used in any of configurations 1 to 15 has a degree of agglomeration of 40% or lower under accelerated test conditions. Accordingly, aggregation of developer can be inhibited, thereby inhibiting firm adhesion of developer to the developer bearer.

Configuration 17: The above-described development device according to any of the configurations 1 through 16 is incorporated in an image forming apparatus that includes at least the latent image bearer such as the photoreceptor 2, a charging member such as the charging member 3, and a latent image forming device such as the exposure unit 6. With this configuration, the image forming apparatus can produce images of reliable quality with image density unevenness reduced.

Configuration 18: In configuration 17, the development device and at least one of the latent image bearer, the charging member, and a cleaning unit, such as the drum cleaning unit 5, are housed in a common unit casing, forming a modular unit or process cartridge removably installed in a body of the image forming apparatus.

With this configuration, the development device and at least one of the components of the process cartridge can be removed at once, and replacement of the development device can be facilitated.

Numerous additional modifications and variations are possible in light of the above teachings. It is therefore to be understood that, within the scope of the appended claims, the disclosure of this patent specification may be practiced otherwise than as specifically described herein.

What is claimed is:

1. A development device comprising:
a developer bearer to carry by rotation developer to a development range facing a latent image bearer; and
a developer regulator to adjust an amount of developer transported to the development range by the developer bearer,
wherein multiple projections are formed in a surface of the developer bearer, and the developer bearer rotates in a reverse direction to a direction of rotation for image development while image development is not performed, and
the developer regulator comprises a blade having a first end held by a regulator holder and a second end that contacts the multiple projections formed in the surface of the developer bearer, the second end disposed in a direction counter to the direction of rotation of the developer bearer for image development.

2. The development device according to claim 1, wherein the developer bearer rotates in the reverse direction immediately after image development is completed.

3. The development device according to claim 1, wherein an edge on a second end side of the blade contacts the developer bearer.

4. The development device according to claim 1, wherein the surface of the developer bearer is made of metal.

5. The development device according to claim 1, wherein the developer regulator is constructed of a material harder than a surface layer of the developer bearer.

6. The development device according to claim 1, wherein the developer regulator is made of metal.

7. The development device according to claim 1, wherein a velocity at which the developer bearer is rotated in the reverse direction is slower than a velocity at which the developer bearer is rotated in the direction of rotation for image development.

8. The development device according to claim 1, further comprising a developer collecting member that contacts the developer bearer to collect developer therefrom,
wherein the developer collecting member includes a porous body, and multiple minute pores are diffused in a surface thereof.

9. The development device according to claim 8, wherein the developer bearer and the developer collecting member rotate in opposite directions in a range where the developer collecting member contacts the developer bearer.

10. The development device according to claim 1, further comprising:
a casing including an opening on a side facing the latent image bearer; and
a seal member to prevent leakage of developer from the opening, the seal member including a first end attached to the casing and a second end disposed to contact the developer bearer.

11. An image forming apparatus comprising:
a latent image bearer;
a charging member to charge a surface of the latent image bearer;
a latent image forming device to form a latent image on the latent image bearer; and
a development device to develop the latent image with developer, the development device comprising:
a developer bearer to carry by rotation developer to a development range facing the latent image bearer;
a developer regulator to adjust an amount of developer transported to the development range by the developer bearer; and
a controller to control rotation of the developer bearer,
wherein multiple projections are formed in a surface of the developer bearer,
the controller causes the developer bearer in a reverse direction to a direction of rotation for image development while image development is not performed, and
the developer regulator comprises a blade having a first end held by a regulator holder and a second end that contacts the multiple projections formed in the surface of the developer bearer, the second end disposed in a direction counter to the direction of rotation of the developer bearer for image development.

12. The image forming apparatus according to claim 11, wherein an edge on a second end side of the blade contacts the developer bearer.

13. The development device according to claim 11, wherein the surface of the developer bearer is made of metal, and the developer regulator is made of metal.

14. The development device according to claim 11, wherein the controller causes the developer bearer to rotate in the reverse direction at a velocity slower than a velocity at which the developer bearer is rotated in the direction of rotation for image development.

15. The development device according to claim 11, wherein the controller causes the developer bearer to rotate a predetermined distance in the reverse direction after image development is completed.

16. The development device according to claim 15, wherein the predetermined distance is greater than a distance between downstream corners of two projections formed in the surface of the developer bearer, the two projections adjacent to each other in the reverse direction.

17. The development device according to claim 11, further comprising a distance measuring unit to measure a rotational distance of the developer bearer,
wherein the controller causes the developer bearer to rotate in the reverse direction when a measured rotational distance of the developer bearer reaches a threshold and image development is not performed.

18. The development device according to claim 11, further comprising an electrical field generator to generate an electrical field between the developer bearer and the developer regulator,
wherein the controller causes the electrical field generator to generate an electrical field for attracting developer to the developer regulator when the developer bearer rotates in the reverse direction.

19. The development device according to claim 11, further comprising a developer collecting member that contacts the developer bearer to collect developer therefrom,
wherein the developer collecting member includes a porous body, and multiple minute pores are diffused in a surface thereof.

20. The development device according to claim 11, wherein the developer is magnetic one-component developer having a degree of agglomeration of 40% or smaller under accelerated test conditions.
